(19) United States
(12) Patent Application Publication
(10) Pub. No.: US 2025/0267637 A1
(43) Pub. Date: Aug. 21, 2025

(54) TEMPORARY CHANGE TO THE BANDWIDTH OF A DIRECT CURRENT NOTCH FILTER OF A DIRECT CURRENT ESTIMATOR OF AN APPARATUS HAVING A DOWNLINK PIPE UTILIZED IN A MULTI-SUBSCRIBER IDENTITY MODULE MODE

(71) Applicant: QUALCOMM Incorporated, San Diego, CA (US)

(72) Inventors: Saranyan NAGARAJAN, Hyderabad (IN); Srinivas PACHAVA, Hyderabad (IN); Prasidh RAMABADRAN, Bangalore (IN); Krishnamitra TANUKU, Hyderabad (IN); Gowrisankar SOMICHETTY, Bangalore (IN); Yogendra Umesh ITANKAR, Hyderabad (IN); Kapil BHATTAD, Bangalore (IN); Parthiban RAJENDRAN, Hyderabad (IN); Priyangshu GHOSH, Hyderabad (IN); Lan LAN, San Diego, CA (US); Qingxin CHEN, San Diego, CA (US); Sriramgopal SRIDHARA, San Diego, CA (US)

(21) Appl. No.: 18/443,044

(22) Filed: Feb. 15, 2024

(51) Int. Cl. H04W 72/0453; H04W 8/20; H04W 72/0446

(52) U.S. Cl. CPC H04W 72/0453; H04W 8/205; H04W 72/0446

(57) ABSTRACT

An apparatus is in a multi-subscriber identity module mode. A first signal in a first plurality of slots associated with a first subscription at a first receiver chain of a downlink pipe and a second signal in a second plurality of slots associated with a second subscription at a second receiver chain of the downlink pipe are received. A difference in timing of a first slot boundary of the first plurality of slots and a second slot boundary of the second plurality of slots is tracked. In response to a change of state of the second receiver chain, a first bandwidth of a direct current (DC) notch filter associated with a DC estimator of the first receiver chain is temporarily increased to a second bandwidth at a same time, prior to, or subsequent to the first slot boundary according to a timing relationship between the first and second boundaries.

### TECHNICAL FIELD

This disclosure relates generally to wireless communication and, more specifically, to a temporary change to the bandwidth of a direct current notch filter of a direct current estimator of an apparatus having a downlink pipe utilized in a multi-subscriber identity module mode.

### INTRODUCTION

A majority of wireless apparatus support a single subscriber identity module (SIM) (also referred to as a Universal Integrated Circuit Card (UICC)). The subscriber may be, for example, a person or a business entity. The SIM may be used to authenticate the subscriber to a network the subscriber uses to access wireless services, the Internet, various applications on remote servers, and cloud services. A SIM is therefore needed by both the subscriber and the subscriber's mobile carrier to ensure that the subscriber has secure network access.

A subscriber may have a first wireless apparatus (e.g., a first cell phone) for personal use and a separate second wireless apparatus (i.e., a second cell phone) for business use. However, more wireless apparatus that support multiple (multi) subscriber identity modules (MSIMs) are being manufactured. MSIM services may be offered to persons or entities that possess multiple wireless apparatus, each with a different subscription, as a way for the person or entity holding the multiple subscriptions to reduce the number of wireless apparatus needed to support the person or entity. The multiple subscriptions authenticated using an MSIM may be from the same wireless carrier or different wireless carriers. Research is ongoing to improve the efficiency of wireless apparatuses that utilize MSIMs.

### BRIEF SUMMARY OF SOME EXAMPLES

The systems, methods, and devices of this disclosure each have several innovative aspects, no single one of which is solely responsible for the desirable attributes disclosed herein.

In one example, a method is disclosed. The method may be practiced at an apparatus. The method includes receiving, in a multi-subscriber identity module mode, a first signal associated with a first subscription at a first receiver chain of a two receiver chain downlink pipe, the first signal conveyed in a first plurality of slots; receiving, in the multi-subscriber identity module mode, a second signal associated with a second subscription at a second receiver chain of the two receiver chain downlink pipe, the second signal conveyed in a second plurality of slots; tracking a difference in timing of a first slot boundary of the first plurality of slots and a second slot boundary of the second plurality of slots; and in response to a change of a state of the second receiver chain, one of: temporarily increasing a first bandwidth of a direct current (DC) notch filter associated with a DC estimator of the first receiver chain to a second bandwidth at a same time as the first slot boundary in response to the first slot boundary and the second slot boundary coinciding, temporarily increasing the first bandwidth to the second bandwidth prior to the first slot boundary in response to the second slot boundary being advanced in time relative to the first slot boundary, or temporarily increasing the first bandwidth to the second bandwidth subsequent to the first slot boundary in response to the second slot boundary being delayed in time relative to the first slot boundary.

In another example, a method is disclosed. The method may be practiced at an apparatus. The method includes receiving a first signal associated with a first subscription at a first receiver chain of a two receiver chain downlink pipe; receiving a second signal associated with a second subscription at a second receiver chain of the two receiver chain downlink pipe; changing a state of the second receiver chain; and temporarily increasing, at a same time as the changing the state of the second receiver chain, a first bandwidth of a direct current (DC) notch filter associated with a DC estimator of the first receiver chain to a second bandwidth.

In still another example, a method is disclosed. The method may be practiced at an apparatus. The method includes receiving, in a multi-subscriber identity module mode, a first signal associated with a first subscription (Sub1) at a first receiver chain of a two receiver chain downlink pipe, the first signal conveyed in a first plurality of slots; receiving, in the multi-subscriber identity module mode, a second signal associated with a second subscription (Sub2) at a second receiver chain of the two receiver chain downlink pipe, the second signal conveyed in a second plurality of slots; tracking a first timing of a Sub1 slot boundary and a Sub2 slot boundary; adjusting a second timing of a change of a state of the second receiver chain from coinciding with the Sub2 slot boundary to coinciding with the Sub1 slot boundary; and temporarily increasing a first bandwidth of a direct current (DC) notch filter associated with a DC estimator of the first receiver chain to a second bandwidth at a same time as the Sub1 slot boundary.

In another example, a method is disclosed. The method may be practiced at an apparatus. The method includes receiving a first signal associated with a first subscription at a first receiver chain of a two receiver chain downlink pipe, the first signal conveyed in a first plurality of slots; receiving a second signal associated with a second subscription at a second receiver chain of the two receiver chain downlink pipe, the second signal conveyed in a second plurality of slots; changing a state of the second receiver chain at a first time; stopping, without resetting, at the first time, an iteration of direct current (DC) estimator loops associated with the first receiver chain; starting, without resetting, at a first slot boundary of the first plurality of slots occurring subsequent to the stopping, the iteration of the DC estimator loops associated with the first receiver chain; and temporarily increasing a first bandwidth of a DC notch filter associated with a DC estimator of the first receiver chain to a second bandwidth at a same time as the starting.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a schematic illustration of an example of a wireless communication system according to some aspects of the disclosure.

FIG. 2 is a schematic illustration of an example of a radio access network according to some aspects of the disclosure.

FIG. 3 is an expanded view of an exemplary subframe, showing an orthogonal frequency division multiplexing (OFDM) resource grid according to some aspects of the disclosure.

FIG. 4 is a block diagram of a portion of a downlink pipe according to some aspects of the disclosure.

FIG. 5 presents graphs representing analog IQ outputs of a first receiver chain and a second receiver chain of an apparatus in a multi-subscriber identity module mode according to some aspects of the disclosure.

FIG. 6 presents graphs representing analog IQ outputs of a first receiver chain of an apparatus in a multi-subscriber identity module mode according to some aspects of the disclosure.

FIG. 7 presents a graph representing analog IQ outputs of a first receiver chain of an apparatus in a multi-subscriber identity module mode according to some aspects of the disclosure.

FIG. 8 is a block diagram of a transceiver according to some aspects of the disclosure.

FIG. 9 is a graph illustrating a change in DC estimator output settling time as a function of the bandwidth of a DC notch filter according to some aspects of the disclosure.

FIG. 10 presents a series of graphs illustrating the timing of an application of gear shifting to a first receiver chain of a downlink pipe in response to changes of state to a second receiver chain of the downlink pipe in an apparatus operating in a multi-subscriber identity module mode according to some aspects of the disclosure.

FIG. 11 and FIG. 12 each present graphs of analog IQ channel outputs of a first receiver chain and a second receiver chain in a single downlink pipe in an apparatus operating in an MSIM mode according to some aspects of the disclosure.

FIG. 13 presents a series of graphs illustrating the timing of an application of gear shifting to a first receiver chain of a downlink pipe in an apparatus according to some aspects of the disclosure.

FIG. 14 is a diagram associated with a state module circuit according to some aspects of the disclosure.

FIG. 15 is a block diagram illustrating an example of a hardware implementation of an apparatus employing one or more processing systems according to some aspects of the disclosure.

FIG. 16 is a flow chart illustrating an example process of wireless communication at an apparatus according to some aspects of the disclosure.

FIG. 17 is a flow chart illustrating an example process of wireless communication at an apparatus according to some aspects of the disclosure.

FIG. 18 is a flow chart illustrating an example process of wireless communication at an apparatus according to some aspects of the disclosure.

FIG. 19 is a flow chart illustrating an example process of wireless communication at an apparatus according to some aspects of the disclosure.

Like reference numbers and designations in the various drawings indicate like elements.

### DETAILED DESCRIPTION

The detailed description set forth below in connection with the appended drawings is directed to some particular examples for the purpose of describing innovative aspects of this disclosure. However, a person having ordinary skill in the art will readily recognize that the teachings herein can be applied in a multitude of different ways. Some or all of the described examples may be implemented in any device, system, or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any apparatus, device, system, or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO), and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to persons having ordinary skill in the art that these concepts may be practiced without these specific details. In some examples, well-known structures and components are shown in block diagram form in order to avoid obscuring such concepts.

While aspects and examples are described in this application by illustration to some examples, persons having ordinary skill in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or user equipment (UE)), end-user devices, etc. of varying sizes, shapes, and constitution.

When a wireless apparatus is in an MSIM mode, the one wireless apparatus may provide wireless voice and data service under a first subscription (Sub1) (e.g., a personal subscription) and other wireless voice and data services under a second subscription (Sub2) (e.g., a business subscription). Use of an MSIM apparatus is not limited to the association of a personal and a business subscription. For example, an MSIM may hold multiple business subscriptions or multiple personal subscriptions. Other types of subscriptions are within the scope of the disclosure.

Apparatus exemplified herein may utilize one or more downlink pipes. Each downlink pipe may include a first receiver chain (e.g., referred to as a primary receiver chain) and a second receiver chain (e.g., referred to as a diversity receiver chain). Each receiver chain of a given downlink pipe may include an antenna (or antenna array), an RF front end (RFFE), a low noise amplifier (LNA), a downconverter (e.g., a mixer receiving an input from the RFFE and receiving a local oscillator (LO) signal from a local oscillator distribution network), a baseband filter, an analog-to-digital converter circuit, and a demodulation circuit. The preceding lists are exemplary and non-limiting. Other circuits, including but not limited to pre-selector filters, automatic gain control circuits, switches, matching networks, additional filters, and conditioning circuits, are all within the scope of the disclosure.

A downlink pipe may be used to exploit a phenomenon referred to as spatial diversity, in which a signal received at a first antenna of the primary receiver chain (referred to as the primary signal) may be the same as the signal received at a second antenna of the diversity receiver chain (referred to as the diversity signal), but the physical paths through space between a transmitter antenna and the primary receiver chain antenna and between the transmitter antenna and the diversity receiver chain antenna may be different (e.g., due to reflections, obstructions, etc.). Thus, the diversity being exploited by this configuration is referred to as spatial diversity.

Apparatus may support a use of a multi-subscriber identity module (MSIM). In some examples, an apparatus supporting an MSIM may be configured to utilize a first downlink pipe for a first subscriber and a second downlink pipe for a second subscriber. However, utilizing two downlink pipes (e.g., a first downlink pipe for Sub1 and a second downlink pipe for Sub2) to receive a first signal associated with a first subscriber and a second signal associated with a second subscriber (where the first and second signals are different) may utilize more hardware and power resources than may be necessary (as each downlink pipe includes two receiver chains, a PRx chain and a DRx chain). In contrast, apparatus exemplified herein may utilize one downlink pipe to receive the signals of two subscribers by configuring a first receiver chain (e.g., the primary receiver chain) of one downlink pipe to receive a first signal associated with a first subscription and a second receiver chain (e.g., the diversity receiver chain) of the same downlink pipe to receive a second signal associated with a second subscription.

The use of one downlink pipe to receive respective signals associated with two subscriptions may provide other advantages (in addition to a more efficient use of hardware resources) that may be overlooked. For example, one missed advantage may be an advantage obtained by sharing the knowledge of both subscription's operating processes, parameters, and/or timing for the benefit of one or both subscriptions. However, today's wireless apparatus may not keep track of the operating processes, parameters, and timing utilized by each subscription (e.g., any thereby not share mutually beneficial knowledge), at least in the sense of not keeping track to provide one subscription with improved performance in view of a tracked aspect of the other subscription.

One example of a lack of a use of shared knowledge may be seen in modem software implementation, where the modem is coupled to a first receiver chain associated with a first subscription (sometimes referred to herein as Sub1) and a second receiver chain associated with a second subscription (sometimes referred to herein as Sub2), yet in such a modem software implementation the Sub1 receiver does not have the knowledge of the Sub2 receiver's slot boundary and vice versa.

Due to advancements in manufacturing processes and an ever-present need to reduce a physical size of RF transceivers, there may be limited on-chip area for RF blocks included in the just-described downlink pipe. The limited on-chip area makes it challenging to achieve on-chip RF isolation between blocks and between components on blocks, where RF isolation may refer to a separation, or a degree of separation, between RF signals of a first block/component and a second block/component. In a downlink pipe example, possibly due to RF isolation and/or other reasons, when one of the receiver chains of a downlink pipe toggles (i.e., changes state from ON to OFF or OFF to ON), there may be a glitch (e.g., manifested as a change of DC average of a desired signal) at the IQ output of the non-toggled receiver chain of the same downlink pipe. This glitch may impact the signal-to-noise ratio (SNR) and/or the block error rate (BLER) performance of the non-toggled receiver chain.

Aspects described herein may be used, for example, to prevent, suppress, counteract, lessen the impact of, or mitigate the just-mentioned glitch in a signal at an IQ output of a non-toggling first receiver chain of a downlink pipe that may be caused by a toggling of a second receiver chain of the same downlink pipe, and thereby improve the SNR/BLER of the signal at the IQ output of the non-toggling first receiver chain of the downlink pipe in a wireless apparatus operating in an MSIM mode.

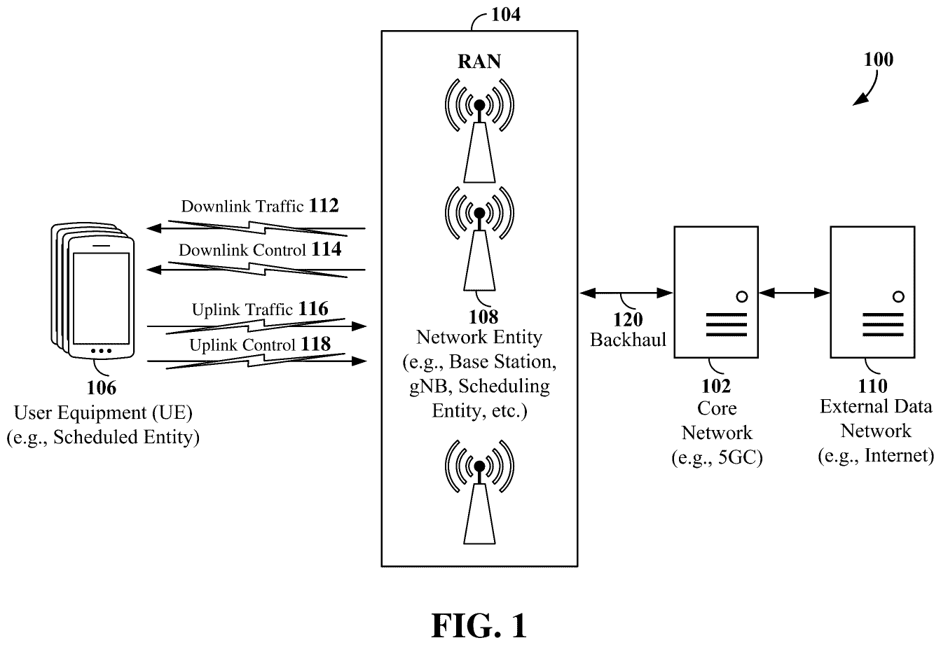

The various concepts presented throughout this disclosure may be implemented across a broad variety of telecommunication systems, network architectures, and communication standards. Referring now to FIG. 1, as an illustrative example without limitation, a schematic illustration of an example of a wireless communication system 100 according to some aspects of the disclosure is presented. The wireless communication system 100 includes three interacting domains: a core network 102, a radio access network (RAN) 104, and a user equipment (UE) 106. By virtue of the wireless communication system 100, the UE 106 (also referred to herein as a wireless communication device) may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (CUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of network entities 108. Broadly, a network entity may be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In some examples, a network entity may be a network element in a radio access network responsible for radio transmission and reception in one or more cells to or from a UE. In different technologies, standards, or contexts, a network entity may variously be referred to by persons having ordinary skill in the art as a base transceiver station (BTS), a radio base station, a base station, a radio transceiver, a transceiver function, a basic service set (BSS), an extended service set (ESS), an access point (AP), a Node B (NB), an eNode B (cNB), a gNode B (gNB), a transmission and reception point (TRP), a scheduling entity, a network entity, or some other suitable terminology. In some examples, a network entity may include two or more TRPs that may be collocated or non-collocated. Each TRP may communicate on the same or different carrier frequency within the same or different frequency band. In examples where the RAN 104 operates according to both the LTE and 5G NR standards, one of the network entities may be an LTE network entity, while another network entity may be a 5G NR network entity.

The RAN 104 is further illustrated supporting wireless communication for multiple mobile apparatuses. A mobile apparatus may be referred to as user equipment (UE) in 3GPP standards, but may also be referred to by persons having ordinary skill in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, a scheduled entity, or some other suitable terminology. A UE 106 may be an apparatus (e.g., a scheduled entity, a user equipment, a wireless communications device, a mobile communication device) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smartphone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of Things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smartwatch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data and/or relevant QoS for transport of critical service data.

Wireless communication between the RAN 104 and the UE 106 may be described as utilizing an air interface. Transmissions over the air interface from a network entity (e.g., similar to network entity 108) to one or more UEs (e.g., similar to UE 106) may be referred to as downlink (DL) transmission. In accordance with certain aspects of the present disclosure, the term downlink may refer to a point-to-multipoint transmission or a point-to-point transmission (e.g., groupcast, multicast, or unicast) originating at a network entity (e.g., network entity 108). Another way to describe this scheme may be to use the term broadcast channel multiplexing. Transmissions from a UE (e.g., UE 106) to a network entity (e.g., network entity 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, where a network entity (e.g., a network entity 108) allocates resources for communication among some or all devices and equipment within its service area or cell. Within the present disclosure, as discussed further below, the network entity (e.g., network entity 108) may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the network entity 108.

Network entities 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, the network entity 108 may broadcast downlink traffic 112 (also referred to as downlink data traffic) to one or more UEs 106. Broadly, the network entity 108 may be a node or device responsible for scheduling traffic (e.g., data traffic, user data traffic) in a wireless communication network, including the downlink traffic 112 and, in some examples, uplink traffic 116 (also referred to as uplink data traffic) from one or more UEs 106 to the network entity 108. On the other hand, the UE 106 (e.g., the scheduled entity) may be a node or device that receives downlink control 114 information, including but not limited to scheduling information (e.g., a grant), synchronization or timing information, or other control information from another entity in the wireless communication network such as the network entity 108. The UE 106 may further transmit uplink control 118 information, including but not limited to a scheduling request or feedback information, or other control information to the network entity 108.

In addition, the uplink control 118 information and/or downlink control 114 information and/or uplink traffic 116 and/or downlink traffic 112 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, the network entity 108 may include a backhaul interface (not shown) for communication with a backhaul portion 120 of the wireless communication system 100. The backhaul portion 120 may provide a link between a network entity 108 and the core network 102. Further, in some examples, a backhaul network may provide interconnection between respective network entities 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5G core (5GC)). In other examples, the core network 102 may be configured according to a 4G evolved packet core (EPC) or any other suitable standard or configuration.

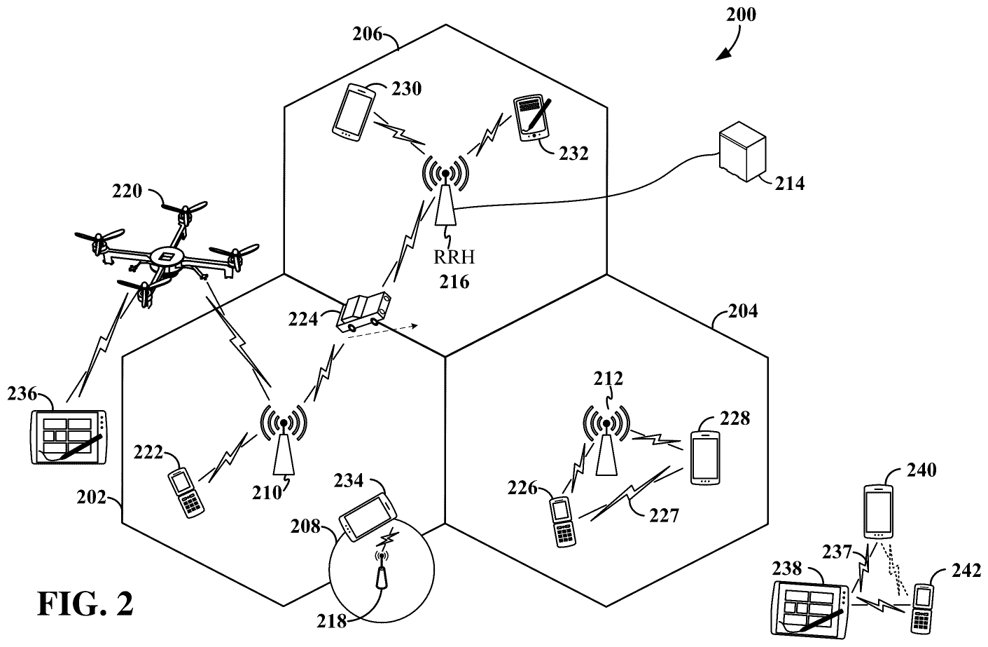

Referring now to FIG. 2, as an illustrative example without limitation, a schematic illustration of an example of a radio access network (RAN) 200 according to some aspects of the disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or network entity. FIG. 2 illustrates cells 202, 204, 206, and 208, each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas, with each antenna responsible for communication with UEs in a portion of the cell.

Various network entity arrangements can be utilized. For example, in FIG. 2, two network entities, referred to as base station 210 and base station 212, are shown in cells 202 and 204. A third network entity, referred to as base station 214, is shown controlling a remote radio head (RRH) 216 in cell 206. That is, a network entity can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a small cell, a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of network entities (e.g., base stations, gNBs, TRPs, scheduling entities) and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the network entity 108 described above and illustrated in FIG. 1.

FIG. 2 further includes an unmanned aerial vehicle (UAV) 220, which may be a drone, quadcopter, octocopter, etc. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210, UEs 226 and 228 may be in communication with base station 212, UEs 230 and 232 may be in communication with base station 214 by way of RRH 216, UE 234 may be in communication with base station 218, and UE 236 may be in communication with mobile base station 220. In some examples, the UEs 222, 224, 226, 228, 230, 232, 234, 236, 238, 240, and/or 242 may be the same as or similar to the one or more UEs 106 described above and illustrated in FIG. 1. In some examples, the UAV 220 may be a mobile network entity and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station (e.g., a network entity). In other examples, two or more UEs (e.g., UEs 226 and 228) within the coverage area of a network entity (e.g., base station 212) may also communicate sidelink signals 227 over a direct link (sidelink) without conveying that communication through the network entity (e.g., base station 212). In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error-correcting block code. In a typical block code, an information message or sequence is split up into code blocks (CBs), and an encoder (e.g., a CODEC) at the transmitting device then mathematically adds redundancy to the information message. The exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a network entity (e.g., an aggregated or disaggregated base station, gNB, cNB, TRP, scheduling entity, etc.), or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell (e.g., cell 202) to the geographic area corresponding to a neighbor cell (e.g., cell 206). When the signal strength or quality from the neighbor cell exceeds that of its serving cell for a given amount of time, the UE 224 may transmit a reporting message to its serving network entity (e.g., base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, where technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into the mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHZ), FR4 (52.6 GHZ-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different subbands of the carrier bandwidth. This type of full-duplex communication may be referred to herein as subband full-duplex (SBFD), also known as flexible duplex.

Deployment of communication systems, such as 5G new radio (NR) systems, may be arranged in multiple manners with various components or constituent parts. In a 5G NR system, or network, a network entity, a network entity, a mobility element of a network, a radio access network (RAN) node, a core network entity, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

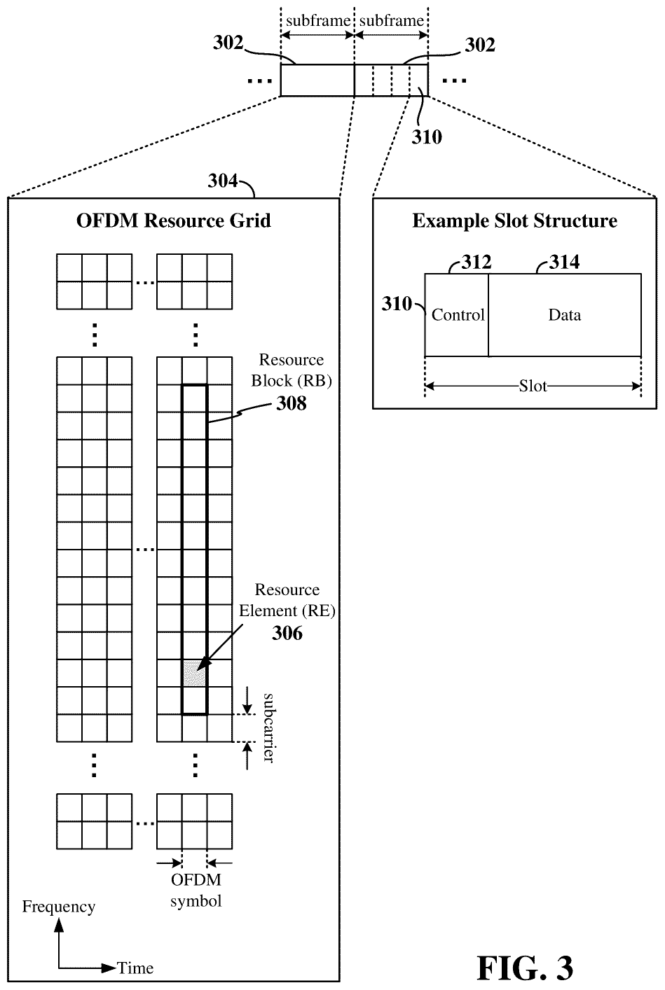

Various aspects of the present disclosure will be described with reference to an OFDM waveform, schematically illustrated in FIG. 3. It should be understood by persons having ordinary skill in the art that the various aspects of the present disclosure may be applied to an SC-FDMA waveform in substantially the same way as described hereinbelow. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid according to some aspects of the disclosure. However, persons having ordinary skill in the art will readily appreciate, the physical (PHY) transmission structure for any particular application may vary from the example described here, depending on any number of factors. Here, time is depicted in the horizontal direction with units of OFDM symbols, and frequency is depicted in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain.

A set of continuous or discontinuous resource blocks may be referred to herein as a Resource Block Group (RBG), subband, or bandwidth part (BWP). A set of subbands or BWPs may span the entire bandwidth. Scheduling of wireless communication devices (e.g., V2X devices, sidelink devices, or other UEs, hereinafter generally referred to as UEs) for downlink, uplink, or sidelink transmissions may involve scheduling one or more resource elements 306 within one or more subbands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a network entity (e.g., an aggregated or disaggregated base station, gNB, eNB, TRP, scheduling entity, etc.) or may be self-scheduled by a UE/sidelink device implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. An additional example may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of slot 310 illustrates that the slot 310 includes a control region 312 and a data region 314. In general, the control region 312 may carry control channels, and the data region 314 may carry data channels. In some examples, a Uu slot (e.g., slot 310) may contain all DL, all UL, or at least one DL portion and at least one UL portion. The structures illustrated in FIG. 3 are merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a network entity, UE, or other similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the network entity may allocate one or more REs 306 (e.g., within the control region 312) of the slot 310 to carry DL control information including one or more DL control channels, such as a physical downlink control channel (PDCCH), to one or more UEs (e.g., scheduled entities). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to persons having ordinary skill in the art, where the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity may further allocate one or more REs 306 (e.g., in the control region 312 or the data region 314) of the Uu slot 310 to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 3, 10, 20, 50, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A network entity may transmit other system information (OSI) as well.

In a UL transmission, the UE (e.g., scheduled entity) may utilize one or more REs 306 of the Uu slot 310 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, a measurement report (e.g., a Layer 1 (L1) measurement report), or any other suitable UCI.

In addition to control information, one or more REs 306 (e.g., within the data region 314) of the Uu slot 310 may be allocated for data traffic. Such data traffic may be carried on one or more traffic channels, such as, for a DL transmission, a physical downlink shared channel (PDSCH); or for a UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, sidelink MAC-CEs may be transmitted in the data region 314 of the slot 310. In addition, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number (e.g., a quantity) of bits of information, may be a controlled parameter based on the modulation and coding scheme (MCS) and the number of RBs in a given transmission.

The channels or carriers described above in connection with FIGS. 1-3 are not necessarily all of the channels or carriers that may be utilized between devices, and persons of ordinary skill in the art will recognize that other channels or carriers may be utilized in addition to those illustrated, such as other traffic, control, and feedback channels.

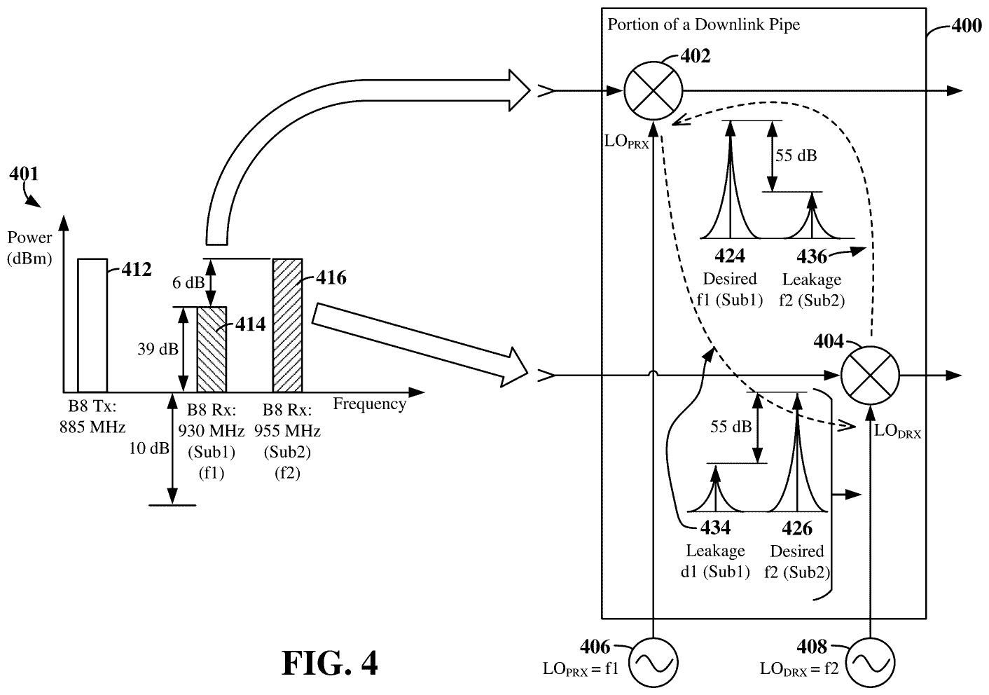

FIG. 4 is a block diagram of a portion of a downlink pipe 400 according to some aspects of the disclosure. The portion of the downlink pipe 400 includes a first mixer 402 and a second mixer 404. The first mixer 402 may be a component of a first receiver chain (e.g., a primary receiver chain (PRx)) (not shown) of the downlink pipe. The second mixer 404 may be a component of a second receiver chain (e.g., a diversity receiver chain (DRx)) (not shown) of the downlink pipe (i.e., the same downlink pipe). The first mixer 402 receives a first local oscillator signal (LO_{PRx}) from a first local oscillator 406. The first local oscillator signal may be at a first frequency (f1). The second mixer 404 receives a second local oscillator signal (LO_{DRx}) from a second local oscillator 408. The second local oscillator signal may be at a second frequency (f2). The illustrations of the first local oscillator 406 and the second local oscillator 408 are provided for case of illustration and not limitation.

In practice, one or more synthesizers (not shown) that may receive inputs from one or more accurate reference frequency sources (not shown) and may be configured for phase lock loop operations with one or more voltage-controlled oscillators (not shown) (e.g., LC oscillators, ring oscillators) may provide both the first frequency (f1) and the second frequency (f2). In some examples, the first local oscillator 406 may be a high-performance synthesizer and the second local oscillator 408 may be a low-performance synthesizer. The terms high-performance and low-performance describe the relative qualities of the synthesizers relative to one another. For example, the high-performance synthesizer may have better phase noise performance than the low-performance synthesizer. The high-performance synthesizer may consume more power than the low-performance synthesizer. The high-performance synthesizer may occupy more chip real estate than the low-performance synthesizer. In general, in circumstances where the second receiver chain (e.g., the DRx chain) is being utilized, for example, to periodically “wake up” and listen for pages for the second subscription, a low-performance synthesizer with its lesser phase noise performance, lower power consumption, and smaller real estate may be satisfactory.

To the left of the portion of the downlink pipe 400 is a graph 401 of three signals in the frequency domain. In the graph 401, frequency is shown along the horizontal axis in units of MHz and power is shown along the vertical axis in units of dBm. The graph 401 is not to scale in frequency or power. The three signals in the graph 401 are representative of the cellular radio band “B8.” Although B8 may be represented as 900 MHz in some literature, the uplink spectrum allotted to B8 is between 880-915 MHZ (inclusive) and the downlink spectrum allotted to B8 is between 925-960 MHZ (inclusive).

According to the example depicted in the graph 401, a transmitter of the wireless apparatus that is associated with the downlink pipe 400 would transmit an uplink signal 412 at 885 MHz. The wireless apparatus would receive a first downlink signal 414 centered at 930 MHz (f1) and a second downlink signal 416 centered at 955 MHz (f2). Although not illustrated, the supported channel bandwidths of B8 are 1.4, 3, 5, and 10 MHZ.

In the example, the wireless apparatus will receive both the first downlink signal 414 at f1 and the second downlink signal 416 at f2 at both a first antenna (not shown) of the primary receiver (PRx) chain (associated with the first mixer 402) and a second antenna (not shown) of the diversity receiver (DRx) chain (associated with the second mixer 404). The first mixer 402 will downconvert the first downlink signal 414 at f1 and the second mixer 404 will downconvert the second downlink signal 416 at f2. In the example, the mixers are part of a transceiver that is part of a direct conversion apparatus. Direct conversion means that the transceiver does not downconvert twice (first to an intermediate frequency and then to the baseband frequency). In direct conversion, each mixer downconverts its incident signal directly to baseband. In this example, f1 is downconverted to 0 Hz, and f2 is also downconverted to 0 Hz. In other words, the first mixer 402 receives the first downlink signal 414 at f1 and mixes the first downlink signal 414 with the output of the first local oscillator 406 (which is also at f1). The second mixer 404 receives the second signal at f2 and mixes the second downlink signal 416 with the output of the second local oscillator 408 (which is also at f2).

In order to avoid having signal power at f1 couple (leak) from the first mixer 402 to the second mixer 404, and in order to avoid having signal power at f2 couple (leak) from the second mixer 404 to the first mixer 402, at levels that will unacceptably impact SNR (for example) of the desired outputs of the mixers, a given amount of isolation must be realized between the two mixers.

According to standards, and as indicated in the graph 401, at the antenna of a primary receiver chain, the undesired second downlink signal 416 may be 6 dB higher than the desired first signal (and vice versa). The 6 dB value may be representative of a performance-based implementation that may provide superior results and a competitive advantage. The 6 dB value may indicate that traffic of Sub1 at f1 must tolerate a page for Sub2 at f2 that is 6 dB higher than the Sub1 traffic (in order for the Sub2 page to not kill the Sub1 traffic). The 39 dB margin is required for acceptable SNR of the first downlink signal 414. To successfully demodulate the first downlink signal 414 in the presence of the second downlink signal 416, the second downlink signal 416 must be at least an additional 10 dB below the 39 dB level of the first downlink signal 414, to cause an acceptable SNR degradation of about 0.4 dB to the first downlink signal. Accordingly (summing the three values), there must be at least 55 dB of isolation between the desired first signal 424 at f1 and the undesired second signal 436 at f2 at the first mixer 402. Similarly, there must be at least 55 dB of isolation between the desired second signal 426 at f2 and the undesired first signal 434 at f1 at the second mixer 404.

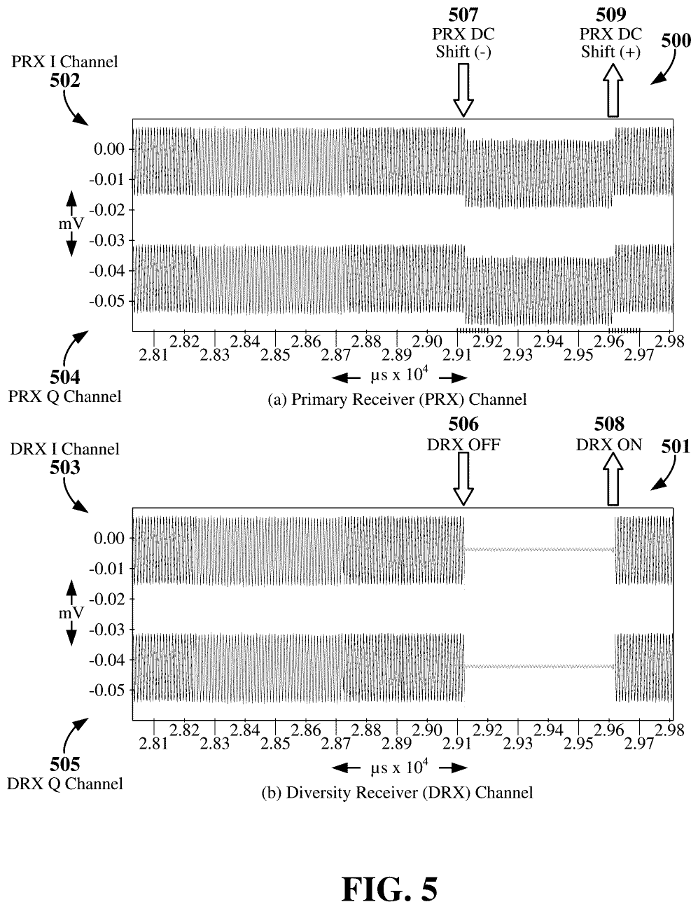

FIG. 5 presents graphs representing analog IQ outputs of a first receiver chain (e.g., a PRx chain) and a second receiver chain (e.g., a DRx chain) of an apparatus in a multi-subscriber identity module (MSIM) mode according to some aspects of the disclosure. In the example of FIG. 5, toggling a state of the second receiver chain causes a DC shift of the analog IQ outputs of the first receiver chain according to some aspects of the disclosure. The upper graph 500 (i.e., FIG. 5a) represents an IQ output of the PRx chain, where the PRx I channel 502 is above the PRx Q channel 504. The lower graph 501 (i.e., FIG. 5b) represents an IQ output of the DRx chain, where the DRx I channel 503 is above the DRx Q channel 505.

In examples where an apparatus is in an MSIM mode, a first receiver chain (e.g., the PRx chain) of a downlink pipe may serve a first subscriber (Sub1), and a second receiver chain (e.g., the DRx chain) of the same downlink pipe may serve a second subscriber (Sub2). A change of state of the second receiver chain is observed to cause a DC shift to the IQ output of the first receiver chain. Here, a change of state may mean turning the power supplied to a receiver chain from ON to OFF or from OFF to ON. When turned OFF, the voltages to some or all of the components of the receiver chain are removed (e.g., set to 0 volts). Additionally, the local oscillator signal supplied to a local oscillator port of a mixer of the receiver chain is removed (e.g., the LO signal is turned off, in contrast to reducing the power of the LO signal or opening a switch between a source of the LO signal and the LO port of the mixer).

As shown in the lower graph 501, a first change of state of the second receiver chain from ON to OFF is identified with a downward pointing block arrow labeled DRx OFF 506. Coincident with the first change of state, as shown in the upper graph 500, a first DC shift in a negative direction of the PRx IQ channels is identified with a downward pointing block arrow labeled PRx DC Shift (−) 507.

As shown in the lower graph 501, a second change of state of the second receiver chain from OFF to ON is identified with an upward pointing block arrow labeled DRx ON 508. Coincident with the second change of state, as shown in the upper graph 500, a second DC shift in a positive direction of the PRx IQ channels is identified with an upward pointing block arrow labeled PRx DC Shift (+) 509.

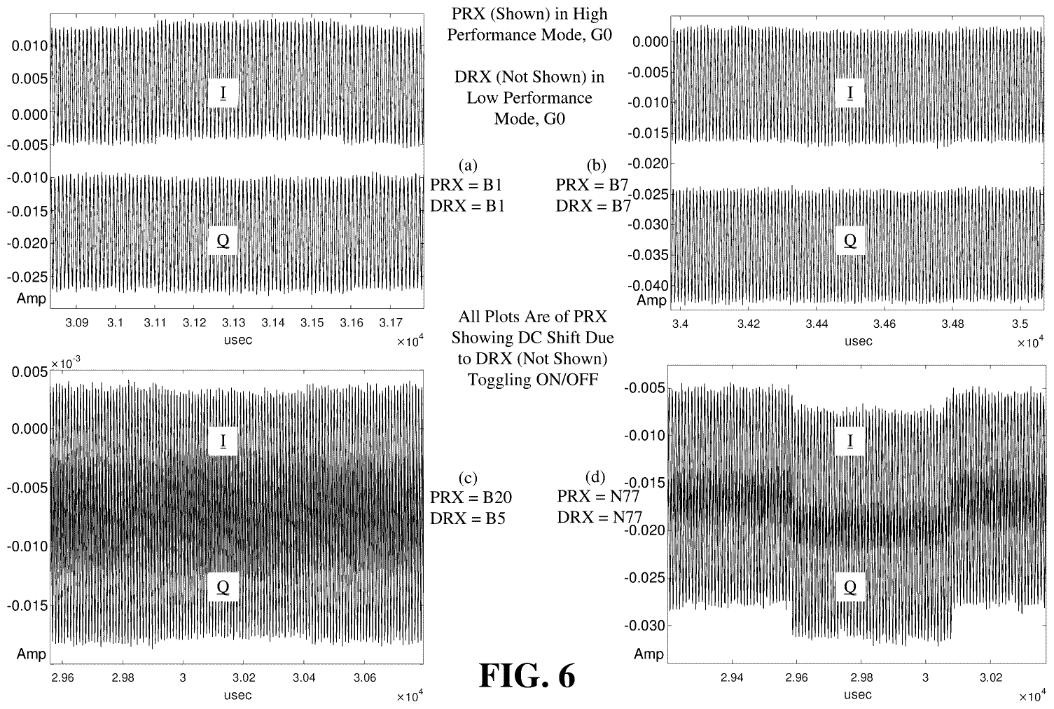

FIG. 6 presents graphs representing analog IQ outputs of a first receiver chain (e.g., a PRx chain) of an apparatus in a multi-subscriber identity module (MSIM) mode according to some aspects of the disclosure. In the example of FIG. 6, toggling a state of the second receiver chain (e.g., a DRx chain) (where the analog IQ outputs of the second receiver chain are not shown) causes a DC shift of the analog IQ outputs of the first receiver chain according to some aspects of the disclosure. In all examples, a first subscriber (Sub1) is served by the PRx chain, a second subscriber (Sub2) is served by the DRx chain, and the DRx chain is toggled between ON and OFF. However, the results would be the same or similar if observing the DRx IQ outputs while toggling ON and OFF the PRx chain.

The upper left graph of FIG. 6a depicts the IQ outputs of a PRx chain in a mid-band scenario, where the PRx and DRx chains of the single downlink pipe are both operating in the BI band (where uplink=1920-1980 MHz and downlink=2110-2170 MHz). In the example of FIG. 6a, the I and Q signals of the PRx chain exhibit a slight DC shift when the DRx chain is toggled between ON and OFF.

The upper right graph of FIG. 6b depicts the IQ outputs of a PRx chain in a high-band scenario, where the PRx and DRx chains of the single downlink pipe are both operating in the B7 band (where uplink=2500-2570 MHz and downlink=2620-2690 MHz). In the example of FIG. 6b, the I and Q signals of the PRx chain exhibit negligible DC shift when the DRx chain is toggled between ON and OFF.

The lower left graph of FIG. 6c depicts the IQ outputs of a PRx chain in a low-band scenario, where the PRx chain of a single downlink pipe operates in the B20 band (where uplink=832-862 MHz and downlink=791-821 MHZ) and the DRx chain of the single downlink pipe operates in the B5 band (where uplink=824-849 MHz and downlink=869-894 MHZ). In the example of FIG. 6c, the I and Q signals of the PRx chain exhibit negligible DC shift when the DRx chain is toggled between ON and OFF.

The lower right graph of FIG. 6d depicts the IQ outputs of a PRx chain in an above 3 GHz scenario, where the PRx and DRx chains of the single downlink pipe are both operating in the n77 band (where downlink=3300-4200 MHZ). In the example of FIG. 6d, the I and Q signals of the PRx chain exhibit a significant DC shift when the DRx chain is toggled between ON and OFF.

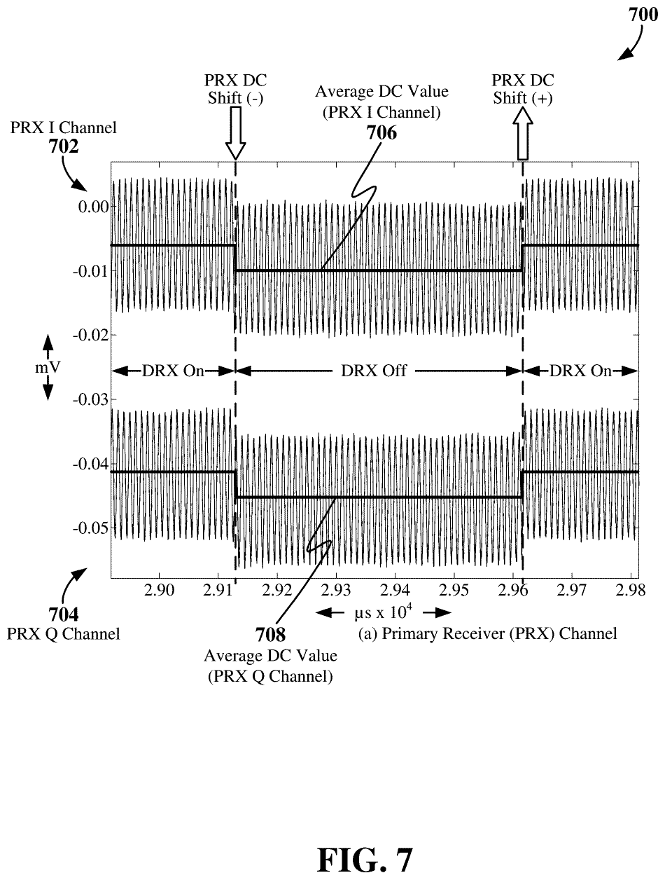

FIG. 7 presents a graph representing analog IQ outputs of a first receiver chain (e.g., a PRx chain) of an apparatus in a multi-subscriber identity module (MSIM) mode according to some aspects of the disclosure. In FIG. 7, toggling a state of the second receiver chain (e.g., a DRx chain) (where the IQ outputs of the DRx chain are not shown) causes a DC shift of the IQ outputs of the primary receiver chain according to some aspects of the disclosure. In the example of FIG. 7, a first subscriber (Sub1) is served by the PRx chain, a second subscriber (Sub2) is served by the DRx chain, and the DRx chain is toggled between ON and OFF. However, the results would be the same or similar if observing the DRx IQ outputs while toggling ON and OFF the PRx chain.

The graph of FIG. 7 depicts the IQ outputs of a PRx chain, where the PRx and DRx chains of the single downlink pipe are both operating in the n96 band (5925-7125 MHz). In the example of FIG. 7, the I and Q signals of the PRx chain exhibit a significant DC shift when the DRx chain is toggled between ON and OFF. Also provided in FIG. 7 are the graphic representations of the average DC value (PRx I channel) 706 and the average DC value (PRx Q channel) 708, depicting the negative and positive DC shifts as the DRx chain is toggled from ON to OFF and OFF to ON. The graph of FIG. 7, when compared to the graphs of FIG. 6, indicates that the DC shift phenomenon may increase with increased frequency.

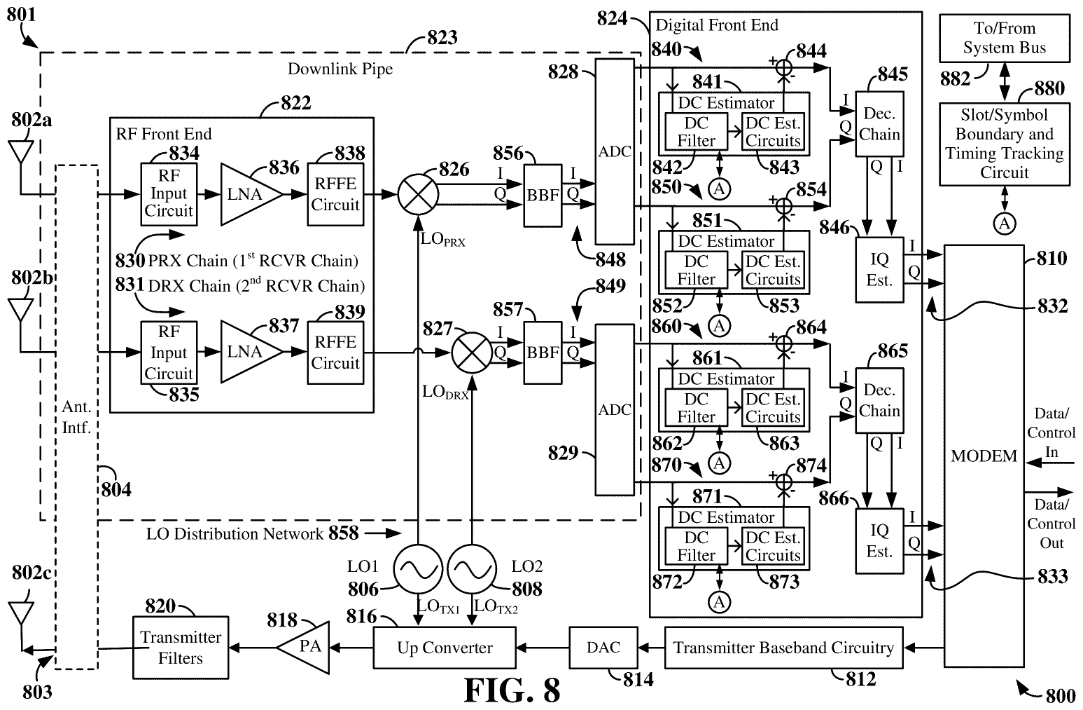

FIG. 8 is a block diagram of a transceiver 800 according to some aspects of the disclosure. The transceiver 800 generally includes a receiver side 801 and the transmitter side 803. One or more antennas and/or antenna arrays, generally represented by an icon of a single antenna, serve both the receiver side 801 and the transmitter side 803. For example, antenna 802a and antenna 802b serve the receiver side 801 and antenna 802c serves the transmitter side 803. In practice, the antennas 802a, 802b, 802c may be shared by the receiver side 801 and the transmitter side 803 via an antenna interface 804 (e.g., an antenna switch module). As used herein, recitation of an antenna encompasses a plurality of antennas, an antenna array, or a plurality of antenna arrays. As used herein, the term “temporary” may mean lasting for a limited duration. For example, temporarily increasing a first bandwidth of a direct current (DC) notch filter (e.g., first DC filter 842) may describe the increase in bandwidth for a predetermined number of symbols (i.e., a limited duration) followed by a reversion of the bandwidth to the first bandwidth after the expiration of the predetermined number of symbols. Expressing the duration in terms of symbols is for exemplary and non-limiting purposes.

The transceiver 800 may have one or more local oscillators, such as the first local oscillator (LO1) 806 and the second local oscillator (LO2) 808 (similar to the first local oscillator 406 and the second local oscillator 408 as shown and described in connection with FIG. 4). The illustrations of the first local oscillator 806 and the second local oscillator 808 are provided for ease of illustration and not limitation. As explained above, in practice, one or more synthesizers (not shown) that may receive inputs from one or more accurate reference frequency sources (not shown) and may be configured for phase lock loop operations with one or more voltage-controlled oscillators (not shown) (e.g., LC oscillators, ring oscillators) and may provide both the first frequency (f1) and the second frequency (f2). In some examples, the first local oscillator 406 may be a high-performance synthesizer and the second local oscillator 408 may be a low-performance synthesizer. The terms high-performance and low-performance describe the relative qualities of the synthesizers relative to one another. For example, the high-performance synthesizer may have better phase noise performance than the low-performance synthesizer. The high-performance synthesizer may consume more power than the low-performance synthesizer. The high-performance synthesizer may occupy more chip real estate than the low-performance synthesizer. In general, in circumstances where the second receiver chain (e.g., the DRx chain) is being utilized, for example, to periodically “wake up” and listen for pages for the second subscription, a low-performance synthesizer with its lesser phase noise performance, lower power consumption, and smaller real estate may be satisfactory. The one or more synthesizers may provide all necessary local oscillator frequencies, LO_{PRx}, LO_{DRx}, LO_{TX1}, and LO_{TX2}, via a local oscillator distribution network 858.

Wireless data and control information may be modulated and coded according to a predetermined modulation and coding scheme and transmitted in an uplink on one or more channels of one or more predetermined bandwidths at a respective channel center frequency (fc).

A modem 810 of the apparatus (e.g., a user equipment) may receive coded digital data and control information and modulate that information. The modem 810 may apply the modulated data and control information to transmitter baseband circuitry 812 for signal conditioning (e.g., filtering, amplification, etc.). The transmitter baseband circuitry 812 output may be applied to a digital-to-analog converter 814. The output of the digital-to-analog converter 814 may be upconverted by an upconverter 816. The upconverter 816 may mix signals input to the upconverter 816 with carrier waveforms obtained from one or more local oscillators, such as LO1 806 and LO2 808, or otherwise obtained from the local oscillator distribution network 858.

The upconverted signals may be amplified by one or more power amplifiers (generally represented by the power amplifier 818) and filtered through one or more filters (generally represented by transmitter filters 820) before being transmitted from the antenna 802c. Of course, the preceding explanation is provided as a broad overview. The data and control information at both the digital and analog stages of the transmitter side 803 may be applied to other and/or additional circuits and processes as known to persons having ordinary skill in the art. The other and/or additional circuits and processes are within the scope of the disclosure.

The receiver side 801 of the transceiver 800 may be divided into one or more downlink pipes, such as downlink pipe 823. The downlink pipe 823 may include two receiver chains: a primary receiver (PRx) chain 830 and a diversity receiver (DRx) chain 831. In some examples, the DRx chain 831 may receive the same signal as the PRx chain 830, but the signal received by the DRx chain 831 may arrive at the antenna 802b of the DRx chain 831 via a physical path that is different from the path taken by the signal received by the antenna 802a of the PRx chain 830. Accordingly, the downlink pipe 823 may be configured to exploit spatial diversity. Other types of diversity, such as frequency diversity and time diversity, are within the scope of the disclosure.

Each of the antenna 802a and the antenna 802b may be coupled to a respective path of an RF front end (RFFE) 822. The respective paths of the RFFE 822 correspond to a PRx chain 830 and a DRx chain 831. The terms “PRx chain” and “DRx chain” are not intended to limit the type of signal applied to and processed by the named receiver chain. For example, the PRx chain 830 and the DRx chain 831 are not limited to operation in support of spatial diversity signal reception.

In other words, the PRx chain 830 may be referred to as a first receiver chain (which may process any signal in any frequency range for which the first receiver chain is configured); likewise, the DRx chain 831 may be referred to as a second receiver chain (which may process any signal in any frequency range for which the second receiver chain is configured). Moreover, the PRx chain 830 and the DRx chain 831 may be interchangeable, meaning, for example, that the digital first I and Q channel outputs 832 associated with the PRx chain 830 (the first receiver chain) and the digital second I and Q channel outputs 833 associated with the DRx chain 831 (the second receiver chain) would be equal if the same input signal is applied to the both the PRx chain 830 and the DRx chain 831.

The antenna 802a may be coupled to a first RF input circuit 834 of the RFFE 822, and the antenna 802b may be coupled to a second RF input circuit 835 of the RFFE 822. Here, the word circuit encompasses one or more circuits. The first RF input circuit 834, and the second RF input circuit 835, may include, but are not limited to, preselector filter banks (not shown), which may include a plurality of bandpass filters coupled between a 1:N demultiplexer switch network and an N:1 multiplexer switch network. One or more processors coupled to one or more memories of the apparatus associated with the transceiver 800 may configure the preselector filter bank to pass the channel(s) associated with a desired signal and attenuate the channel(s) associated with undesired signals. The first RF input circuit 834 and the second RF input circuit 835 may also include, but are not limited to, one or more matching circuits configured to match an input impedance of a low noise amplifier (LNA) (e.g., a first LNA 836, a second LNA 837) to an output impedance of a corresponding matching circuit. Persons having ordinary skill in the art will understand that other and/or additional circuits may be included in the first RF input circuit 834 and the second RF input circuit 835; such other and/or additional circuits are within the scope of the disclosure.

The outputs of the first RF input circuit 834 and the second RF input circuit 835 may be coupled to the first LNA 836 and the second LNA 837, respectively. The first LNA 836 and the second LNA 837 may be configured to amplify weak (e.g., low power) input signals, having present signal-to-noise ratios that may be low, while limiting further degradation of the present signal-to-noise ratios.

The outputs of the first LNA 836 and the second LNA 837 may be coupled to a first RFFE circuit 838 and a second RFFE circuit 839, respectively. Here, the word circuit encompasses one or more circuits. Each of the first RFFE circuit 838 and the second RFFE circuit 839 may include, but are not limited to, LNA output matching circuits, filtering circuits, additional amplifier circuits, and automatic gain control circuits. Persons having ordinary skill in the art will understand that other and/or additional circuits may be included with the first RFFE circuit 838 and the second RFFE circuit 839; such other and/or additional circuits are within the scope of the disclosure.

The first RFFE circuit 838 output may be coupled to a first mixer 826 of the downlink pipe 823. The second RFFE circuit 839 output may be coupled to a second mixer 827 of the downlink pipe 823. The first mixer 826 may mix a first signal (e.g., a primary signal, a first subscription Sub1 signal) received at the PRx chain 830 with a local oscillator frequency (LO_{PRx}) to downconvert the first signal to either an intermediate frequency or a baseband frequency. The transceiver 800 may implement direct conversion, where the one or more processors coupled to the one or more memories of the apparatus served by the transceiver 800 may be configured to tune LO1 806 to the center frequency of a desired signal received at the antenna 802a, to effectuate the direct downconversion of the desired signal to 0 Hz.

Similarly, the second mixer 827 may mix a second signal (e.g., a diversity signal, a second subscription Sub2 signal) received at the DRx chain 831 with an output of the second local oscillator, LO2 808, to downconvert the second signal to either an intermediate frequency or a baseband frequency. As noted, however, the transceiver 800 may implement a direct conversion, where the one or more processors coupled to the one or more memories of the apparatus served by the transceiver 800 may be configured to tune LO2 808 to the center frequency of a desired signal received at the antenna 802b, to effectuate the direct downconversion of the desired signal to 0 Hz.

The output of the first mixer 826 provides analog first I and Q channels corresponding to the first signal. The output of the second mixer 827 provides analog second I and Q channels corresponding to the second signal. The analog first I and Q channels may be input to a first baseband filter 856. The analog second I and Q channels may be input to a second baseband filter 857.

The first I and Q channel outputs 848 of the first baseband filter 856 of the downlink pipe 823 may be coupled to corresponding first I and Q channel inputs of a first analog-to-digital converter (ADC) (hereinafter the first ADC 828). The first I and Q channel outputs of the first ADC 828 may be coupled to first I and Q channel inputs of a digital front end 824. Similarly, the second I and Q channel outputs 849 of the second baseband filter 857 of the downlink pipe 823 may be coupled to corresponding second I and Q channel inputs of a second analog-to-digital converter (hereinafter the second ADC 829). The second I and Q channel outputs of the second ADC 829 may be coupled to second I and Q channel inputs of the digital front end 824.

For example, the digital front end 824 may include multiple circuits configured to remove imperfections from the digital IQ outputs of the first ADC 828 and the second ADC 829. Examples of such circuits include but are not limited to DC estimator circuits, residual sideband canceller circuits, DC canceller circuits, spur estimation and cancelation circuits, scaling and truncation circuits, filter circuits including but not limited to DC notch, low pass, root raised cosine, and anti-drooping filter circuits, summing circuits, decimation chain circuits, IQ estimation circuits, and IQ compensation circuits. To avoid cluttering the drawing and for purposes of illustration and not limitation, FIG. 8 illustrates blocks for only DC estimators, including but not limited to DC notch filters and associated DC estimator circuits, summing circuits, decimator chain circuits, and IQ estimation circuits. Persons having skill in the art will understand that the illustrated circuits, the just mentioned circuits, and/or other circuits and combinations and chains of circuits may be included in the digital front end 824 and that all such circuits are within the scope of the disclosure.

Turning now to the illustration of the exemplary digital front end 824 of FIG. 8, the first I channel input and the first Q channel input of the digital front end 824 may be coupled to a first summing circuit 844, and a second summing circuit 854, respectively. The first summing circuit 844 output and the second summing circuit 854 output may be coupled to a first decimator chain 845 of the digital front end 824. The I and Q channel outputs of the first decimator chain 845 may be coupled to the I and Q channel inputs of a first IQ estimator circuit 846. The I and Q channel outputs 832 of the first IQ estimator circuit 846 may be coupled to the first IQ channel inputs of the modem 810.

The first I and Q channels and the second I and Q channels of the digital front end 824 may be the same or similar. For brevity, the first I channel of the digital front end 824 is described. The descriptions of the first Q channel, the second I channel, and the second Q channel are the same or similar to the description of the first I channel. Here, circuits with similar numbers correspond to the same or similar circuits, which may have the same or similar functions and the same or similar modes of operation. For example, the first DC filter 842, the second DC filter 852, the third DC filter 862, and the fourth DC filter 872 may have the same or similar circuit configurations, perform the same or similar functions, and have the same or similar modes of operation.

Returning to the first I channel input of the digital front end 824, a first DC estimator 841 input may be coupled to the first I channel input. The first DC estimator 841 input may be coupled to the first DC filter 842. The first DC filter 842 may be a DC notch filter (sometimes alternatively described as a highpass filter). The one or more processors coupled to the one or more memories of the apparatus may be configured to temporarily change the first DC filter 842 bandwidth from a first value to a second value, wider than the first value, and then revert the bandwidth to the first value. The one or more processors may configure the first DC filter 842 bandwidth via a coupling of the first DC filter 842 to the system bus 882. In some examples, the coupling may be via a slot/symbol boundary and timing tracking circuit 880, which may also be coupled to the system bus 882. The one or more processors coupled to the one or more memories of the apparatus may obtain data (e.g., shared knowledge of the timing of slot/symbol boundaries between Sub1 and Sub2 signals) from the slot/symbol boundary and timing tracking circuit 880 and may base timings of the temporary changes in bandwidth at least in part on the obtained data.

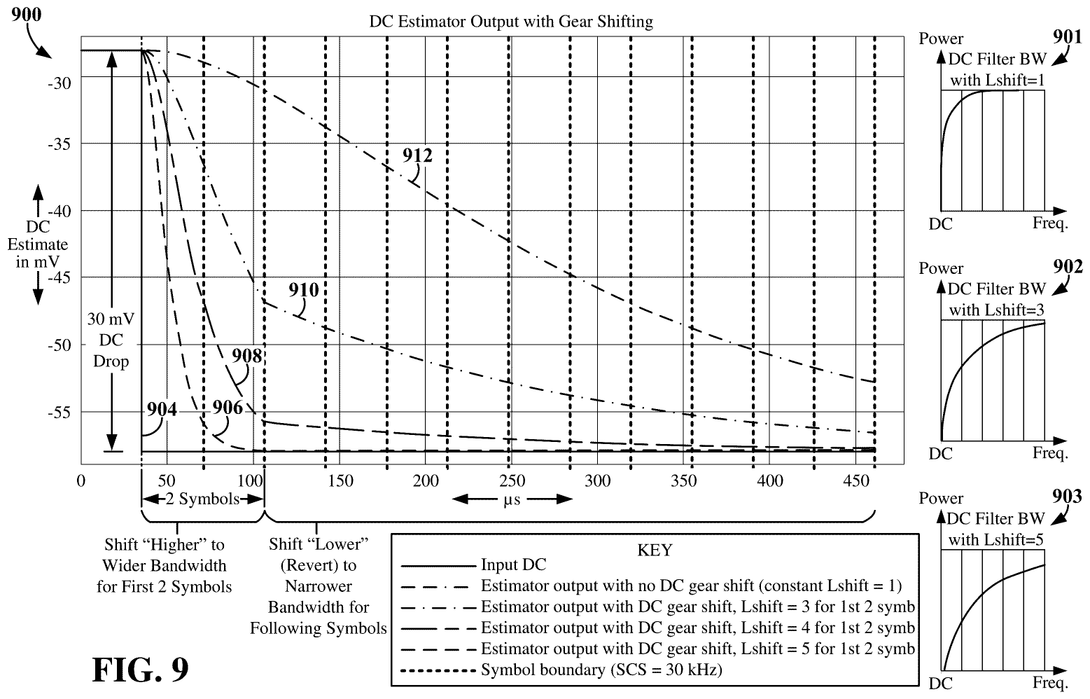

Graphic examples of (temporary) changes to the bandwidth of the first DC filter 842 are shown in the inset first graph 901, second graph 902, and third graph 903 to the right of graph 900 of FIG. 9. Temporarily increasing the bandwidth of the first DC filter 842 may reduce the time it takes the first DC estimator 841 to settle to a final estimated DC value. Temporarily increasing the bandwidth of a DC filter and then reverting to the original bandwidth may be referred to as “gear shifting” herein. Gear shifting “up” increases the bandwidth, and gear shifting “down” decreases the bandwidth and may revert the bandwidth to its original value.

The first DC filter 842 output may be coupled to the first DC estimator circuit 843 input. The first DC estimator circuit 843 output may be coupled to the first summing circuit 844. The first summing circuit 844 may sum the first I channel input received at the digital front end 824 with the first DC estimator circuit 843 output. The summation may provide a feed-forward loop to the first DC estimator circuit 843 input, adding to or subtracting from a DC value output from the first ADC 828.

Persons having ordinary skill in the art will understand that the first DC estimator 841 may include additional circuits beyond those illustrated in FIG. 8. In some examples, multiple DC estimator loops 840, generally represented by the first DC estimator 841 and first summing circuit 844 loop, may be provided to improve the accuracy of the first DC estimator 841. Additional examples of DC estimator loops 850, 860, 870 are also depicted.

The first Q channel, the second I channel, and the second Q channel of the digital front end 824 are the same or similar to the first I channel of the digital front end 824 in that components having similar reference numerals may perform the same or similar functions. For the sake of brevity, the explanation of the first I channel of the digital front end will not be repeated for each of the remaining ones of the first Q channel, the second I channel, and the second Q channel of the digital front end 824.

A downlink pipe, such as the downlink pipe 823 of FIG. 8, may be used with an apparatus configured in an MSIM mode. For example, when configured to operate in an MSIM mode, instead of utilizing the primary receiver chain in connection with a primary signal and the diversity receiver chain in connection with a diversity signal, the primary receiver chain may be used in connection with a first signal of a first subscription (Sub1) and the diversity receiver chain may be used in connection with a second signal of a second subscription (Sub2).

However, a problem may arise with using the downlink pipe 823 in an apparatus operating in an MSIM mode. In the MSIM mode, data and control signals associated with a first subscription (Sub1) may be received on the PRx chain 830, while data and control signals associated with a second subscription (Sub2) may be received on the DRx chain 831. There may come a time when the DRx chain is turned off. For example, the DRx chain 831 may enter a discontinuous reception period, in which case the power may be removed from most or all of the components of the DRx chain 831 and the local oscillator signal applied to the mixer of the DRx chain may be removed. As a result, a glitch may occur in the baseband analog IQ output. Specifically, the average DC value of the downconverted signal in the PRx chain 830 may shift. The DC estimation circuit may take some time to process this shift. However, until the DC estimation circuitry has settled to an accurate estimation, the signal-to-noise ratio of the digitized downconverted signal is degraded.

FIG. 9 is a graph 900 illustrating a change in DC estimator output settling time as a function of the bandwidth of a DC notch filter according to some aspects of the disclosure. Symbol boundaries spaced at 35 μs (corresponding to numerology=1, normal CP, subcarrier spacing (SCS)=30 kHz, 14 symbols/slot) are represented by short-dashed vertical lines. The DC estimator may be similar to the DC estimators 841, 851, 861, 871, as shown and described in connection with FIG. 8. The DC notch filter may be similar to the DC filters 842, 852, 862, 872, as shown and described in connection with FIG. 8. In FIG. 9, time is represented on the horizontal axis in units of μs. DC estimator output voltage is represented on the vertical axis in units of mV.

Gear Shifting (GS) is a process of temporarily widening the bandwidth of a DC notch filter (e.g., a highpass filter) and then reverting the bandwidth to its original value. Temporarily widening the bandwidth may allow the DC notch (or the output of the DC estimator) to have a reduced settling time compared to the settling time obtained if the narrower bandwidth was used exclusively (i.e., without any temporary widening of the bandwidth). By reducing the settling time, the number of symbols impacted by the previously described and undesired DC shift is reduced, and DC is more rapidly canceled from the output of the DC estimator, leading to signal-to-noise ratio improvement.

In FIG. 9, a step-function-like change to a DC input 904 voltage to a DC estimator (e.g., similar to DC estimators 841, 851, 861, 871, as shown and described in connection with FIG. 8) is represented as a 30 mV drop in DC voltage. That is, an initial input voltage to the DC estimator is approximately −28 mV and a final input voltage to the DC estimator is approximately −58 mV. The initial value of −28 mV and the delta value of 30 mV are used for illustration and discussion and are not intended to be limiting.

To the right of the graph 900 are three graphs representing three bandwidths of the DC notch filter in the frequency domain, where frequency (e.g., in Hz or MHz) is represented on the horizontal axis and power (e.g., in dB) is represented on the vertical axis. The first graph 901 corresponds to a narrowest bandwidth of the DC notch filter, where an Lshift value is equal to 1. The term “Lshift” describes a parameter utilized to implement a notch filter according to some examples. The second graph 902 corresponds to a bandwidth of the DC notch filter that is wider than the bandwidth represented in the first graph 901, yet narrower than the bandwidth represented in the third graph 903. In the second graph 902, the Lshift value is equal to 3. The third graph 903 corresponds to a widest bandwidth of the DC notch filter (for this example), where the Lshift value is equal to 5. The DC notch filter may be thought of as a highpass filter. As the Lshift value increases, the 3 dB point of the filter shifts to the right on the frequency axis, hence “widening” the notch in the frequency domain (and described herein as widening the bandwidth of the notch filter).

A first trace 906 represents the output of the DC estimator where the bandwidth of the DC notch filter is temporarily changed from an original first value (i.e., bandwidth realized for DC notch filter Lshift=1) to a greatest value (i.e., the greatest value for this example) (were the greatest value of the bandwidth realized for DC notch filter in this example corresponds to Lshift=5) for the first two symbols of the analog output of the non-toggled receiver chain of a downlink pipe of an apparatus in an MSIM operating mode according to some aspects of the disclosure.

A second trace 908 represents the output of the DC estimator where the bandwidth of the DC notch filter is temporarily changed from an original first value (i.e., bandwidth realized for DC notch filter Lshift=1) to a greater value (i.e., the bandwidth realized for DC notch filter with Lshift=4) for the first two symbols of the analog output of the non-toggled receiver chain of the downlink pipe of the apparatus in the MSIM operating mode according to some aspects of the disclosure.

A third trace 910 represents the output of the DC estimator where the bandwidth of the DC notch filter is temporarily changed from an original first value (i.e., bandwidth realized for DC notch filter Lshift=1) to a greater value (i.e., the bandwidth realized for DC notch filter with Lshift=3) for the first two symbols of the analog output of the non-toggled receiver chain of the downlink pipe of the apparatus in the MSIM operating mode according to some aspects of the disclosure.

A fourth trace 912 represents the output of the DC estimator where the bandwidth of the DC notch filter is not changed (not gear shifted) and remains at the bandwidth realized for DC notch filter Lshift=1 for all symbols (including the first two symbols) of the analog output of the non-toggled receiver chain of the downlink pipe of the apparatus in the MSIM operating mode according to some aspects of the disclosure.

As illustrated by a comparison of the fourth trace 912 (without gear shifting) to the first trace 906 (with maximum gear shifting for two symbols in this example), it may be observed that without gear shifting, the DC notch (or the output of the DC estimator) will take significant time to settle. With the gear shifting example of the first trace 906, it may be observed that the output of the DC estimator settles to the final value of −58 mV within the first two symbols of the analog IQ output of the non-toggled receiver chain. Without gear shifting, the DC impairment (due to the undesired DC shift) will be present in the analog output of the non-toggled receiver chain until the DC notch (or the output of the DC estimator) settles (and as shown in the example of the fourth trace 912, the settling occurs sometime after the twelve symbols illustrated in the graph 900). As a result of not using gear shifting, a greater number of symbols will be impacted by the undesired DC shift (i.e., there would be a degradation of the signal-to-noise ratio of that greater number of symbols) compared to the number of symbols impacted by the undesired DC shift when gear shifting is utilized.

Described herein are examples of the use of “cross-subscription” knowledge of slot boundaries and a use of gear shifting to mitigate the DC impairment (i.e., mitigate the undesired DC shift) in the analog IQ output of a non-toggling first receiver chain due to a toggling of a second receiver chain within a single downlink pipe of an apparatus operating in an MSIM mode. Control of the timing of an application of gear shifting to the DC estimator of the non-toggled receiver chain (i.e., the first receiver chain) may minimize the SNR impact to the number of symbols of the signal output from the first receiver chain, whose signal-to-noise ratio is decreased due to the toggling of the second receiver chain, in the two receiver chains of a given downlink pipe (e.g., in an apparatus operating in an MSIM mode).

One example of a DC estimator may operate according to the equation DC_est(n)=alpha*x(n)+(1−alpha)*DC_est(n−1), where the weights alpha, and 1-alpha (also referred to as beta) correspond to different degrees of gear shifting, x(n) corresponds to the present input, DC_est(n) is the present DC estimate, and DC_est(n−1) is the previous DC estimate. According to the exemplary equation, the present DC estimate (DC_est(n)) corresponds to the present input (x(n)) weighted up by alpha plus the previous DC estimate (DC_est(n−1)) weighted down by (1-alpha).

All the above described gear shifting based DC cancellation methodologies hold good and are equally applicable even if the first receiver chain was toggling and the gear shifting is being applied on the second receiver chain (non-toggling chain).

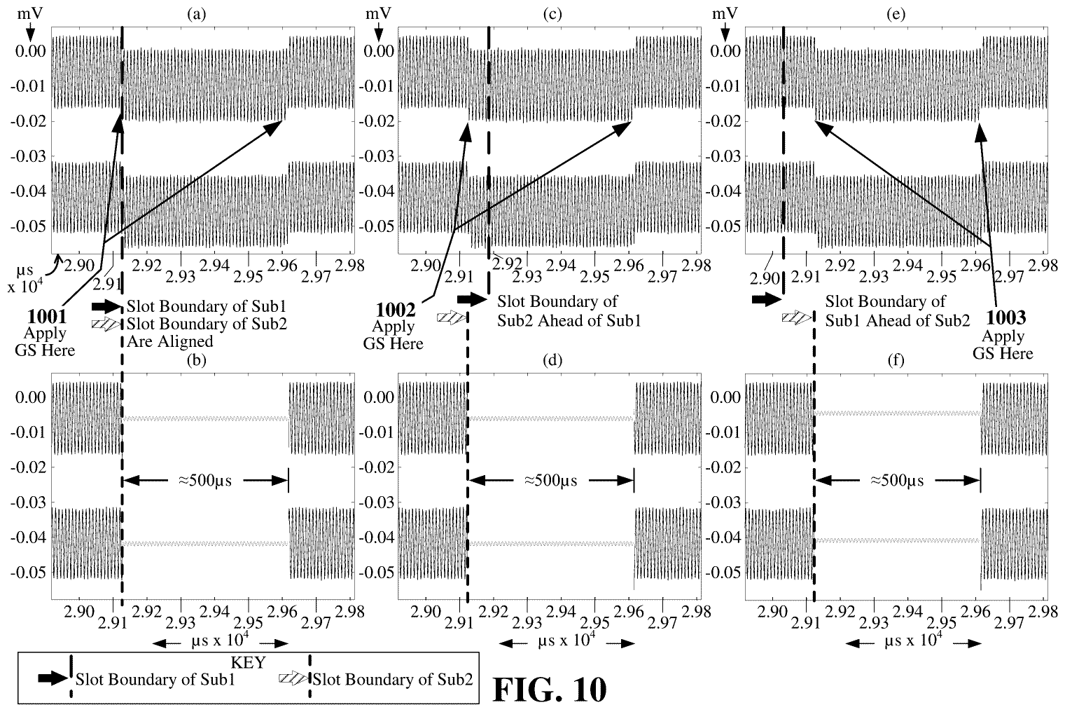

FIG. 10 presents a series of graphs illustrating the timing of an application of gear shifting to a first receiver chain of a downlink pipe in response to changes of state to a second receiver chain of the downlink pipe in an apparatus operating in a multiple subscriber identity module mode according to some aspects of the disclosure. As described in more detail below, examples herein utilize the knowledge of the slot boundaries of both the first subscription (Sub1) and the second subscription (Sub2) signals and employ gear shifting to mitigate the DC impairment to the analog IQ outputs of a first receiver chain of a single downlink pipe resulting from a change of state (e.g., a toggling from ON to OFF or OFF to ON) of a second receiver chain of the single downlink pipe. In the examples, an apparatus utilizes the single downlink pipe in an MSIM mode. In some examples, the knowledge of the slot boundaries of both the first subscription (Sub1) and the second subscription (Sub2) signals may be referred to as “Cross-Sub knowledge.”

FIG. 10 depicts examples of the analog IQ channel outputs of first and second receiver chains (e.g., the PRx and DRx chains, respectively), where FIGS. 10a, 10c, and 10e correspond to the I (top) and Q (bottom) channels of the first receiver chain and FIGS. 10b, 10d, and 10f correspond to the I (top) and Q (bottom) channels of the second receiver chain. In FIG. 10, time is shown on the horizontal axis in units of μs×10⁴ and output voltage is shown on the vertical axis in units of mV. Vertical and/or horizontal axis identification has been removed from some graphs to avoid cluttering the drawings. In the example of FIG. 10, numerology 1 is utilized, where each slot is 0.5 ms (500 μs) and there are 14 symbols per slot. Sub1 traffic is present throughout the duration of each of FIGS. 10a, 10c, and 10c. Sub2 traffic (different from Sub1 traffic) is present at the beginnings and ends of the durations of FIGS. 10b, 10d, and 10f; however, in the middle of the durations, for one slot (duration 500 μs) the second receiver chain is OFF (and Sub2 is presumed to be idle).

FIG. 10 exemplifies an application of gear shifting in connection with the first subscription (Sub1) signal served by the first receiver chain (e.g., the PRx chain) of a downlink pipe in response to the toggling (i.e., the change of state) of the second receiver chain (e.g., the DRx chain) of the downlink pipe. A second subscription (Sub2) signal is associated with the second receiver chain. The gear shifting may be implemented in connection with a tracking of a difference in timing between the Sub1 and Sub2 slot boundaries. The timing between slot boundaries illustrated in FIG. 10 is exemplary and not intended to be limiting. In some examples, the tracking of the difference in timing may be performed by a slot/symbol boundary and timing tracking circuit (similar to the slot/symbol boundary and timing tracking circuit 880 as shown and described in connection with FIG. 8). In other examples, the tracking of the difference in timing may be performed by one or more other circuits in the processing system of the apparatus.

In the example of FIG. 10, the one or more processors of the apparatus employing a single downlink pipe in an MSIM mode may obtain the knowledge of the Sub1 and Sub2 slot boundaries. Using this knowledge, the one or more processors of the apparatus may configure gear shifting to a DC notch filter of a DC estimator circuit (similar to the first DC filter 842 and the first DC estimator 841 as shown and described in connection with FIG. 8) associated with the first receiver chain (i.e., the non-toggling receiver chain) according to some aspects of the disclosure. The one or more processors may implement the gear shifting (i.e., the temporary changing of a bandwidth of the DC notch filter from a first bandwidth to a second bandwidth, wider than the first bandwidth, and reversion of the bandwidth from the second bandwidth back to the first bandwidth) at predetermined times relative to the known slot boundaries. In some examples, the application of gear shifting may be in response to the toggling of the second receiver chain, which may cause an undesired DC shift in the analog IQ output of the first receiver chain (the non-toggled receiver chain). The toggling of the second receiver chain may cause a change to the load of a local oscillator power supply, which in turn may cause the undesired DC shift in the analog IQ output of the first receiver chain (the non-toggled receiver chain). As stated above, the gear shifting may reduce a number (i.e., a quantity) of the symbols adversely impacted by the undesired DC shift (adversely impacted, for example, by a reduction in the signal-to-noise ratio of the adversely impacted symbols). Reducing the number of adversely impacted symbols improves the overall signal-to-noise ratio observed on the IQ lines of the non-toggling receiver chain during, or in response to, the toggling of the other receiver chain in the single downlink pipe (e.g., of the apparatus operating in an MSIM mode).

Three examples of slot boundary relationships are depicted in FIG. 10. In the first example, utilizing FIGS. 10a and 10b, the first slot boundary of the Sub1 signal served by the first receiver chain and the second slot boundary of the Sub2 signal served by the second receiver chain are aligned. In this first example, reference numeral 1001 identifies the points in time where gear shifting (GS) is applied. In the second example, utilizing FIGS. 10c and 10d, the second slot boundary of the Sub2 signal served by the second receiver chain is ahead of (i.e., leads, precedes) the first slot boundary of the Sub1 signal served by the first receiver chain. In this second example, reference numeral 1002 identifies the points in time where gear shifting (GS) is applied. In the third example, utilizing FIGS. 10e and 10f, the first slot boundary of the Sub1 signal served by the first receiver chain is ahead of (i.e., leads, precedes) the second slot boundary of the Sub2 signal served by the second receiver chain. In this third example, reference numeral 1003 identifies the points in time where gear shifting (GS) is applied.

According to some aspects, the examples of FIG. 10 may be used to describe a method operational at a wireless apparatus that may include a multi-subscriber identity module. For example, the method may include receiving, in a multi-subscriber identity module mode, a first signal associated with a first subscription (e.g., the traffic illustrated in FIGS. 10a, 10c, and 10c) at a first receiver chain (e.g., a PRx chain) of a two receiver chain downlink pipe, the first signal conveyed in a first plurality of slots. The method may further include receiving, in the multi-subscriber identity module mode, a second signal associated with a second subscription (e.g., the traffic illustrated in FIGS. 10b, 10d, and 10f) at a second receiver chain (e.g., a DRx chain) of the two receiver chain downlink pipe, the second signal conveyed in a second plurality of slots. Still further, the method may include tracking a difference in timing of a first slot boundary of the first plurality of slots and a second slot boundary of the second plurality of slots, and in response to a change of a state of the second receiver chain (e.g., the center slot in FIGS. 10b, 10d, and 10f where the second receiver is toggled form ON to OFF and then from OFF to ON), one of: temporarily increasing a first bandwidth of a DC notch filter associated with a DC estimator of the first receiver chain to a second bandwidth at a same time as the first slot boundary in response to the first slot boundary and the second slot boundary coinciding (e.g., where the term “coinciding” may mean occurring at or during the same time, as illustrated in the first example of FIGS. 10a and 10b), temporarily increasing the first bandwidth to the second bandwidth prior to the first slot boundary in response to the second slot boundary being advanced in time relative to the first slot boundary (e.g., as illustrated in connection with the second example of FIGS. 10c and 10d), or temporarily increasing the first bandwidth to the second bandwidth subsequent to the first slot boundary in response to the second slot boundary being delayed in time relative to the first slot boundary (e.g., as illustrated in connection with the third example of FIGS. 10c and 10f).

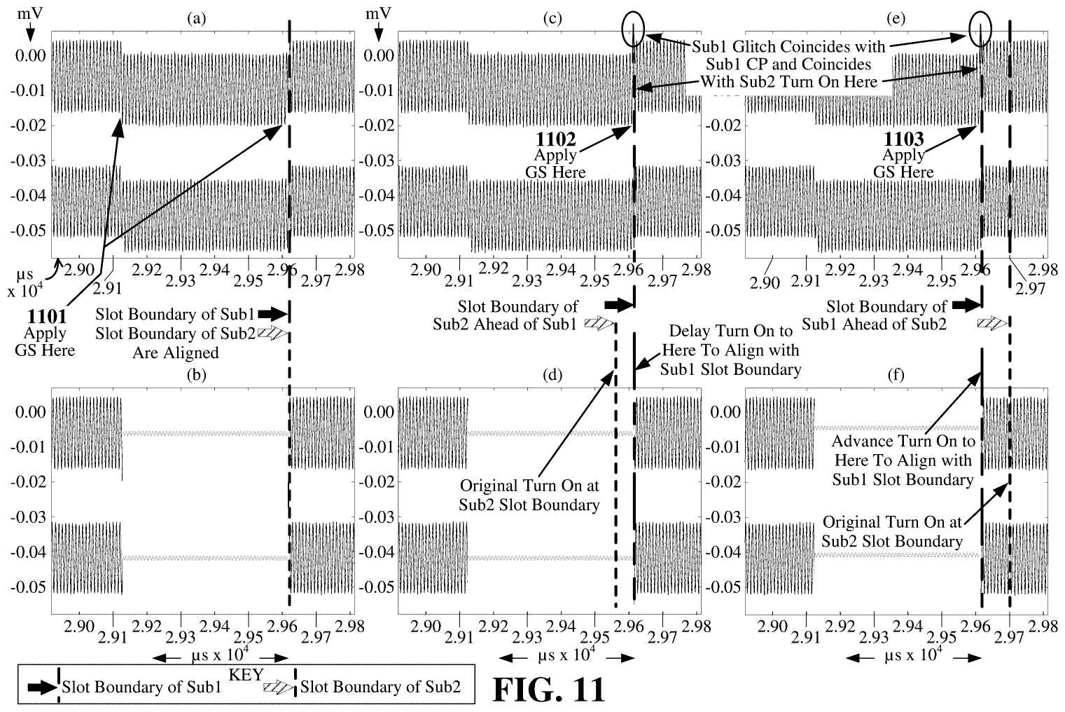

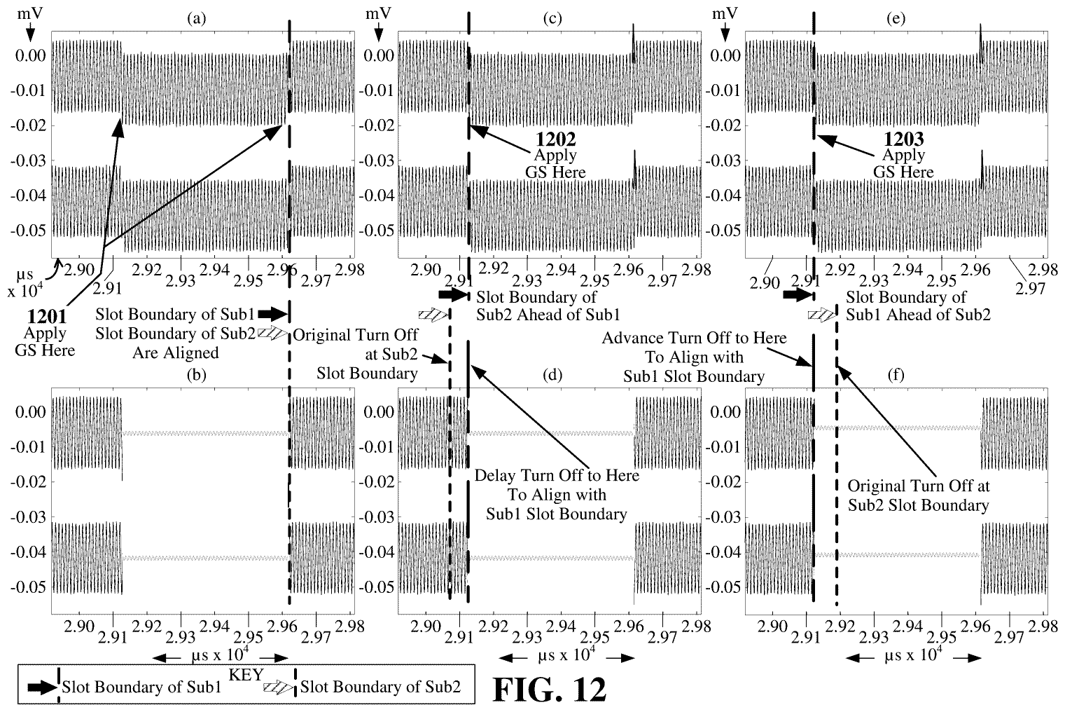

FIG. 11 and FIG. 12 each present graphs of analog IQ channel outputs of a first receiver chain (e.g., a PRx chain) (upper graphs a, c, c) and a second receiver chain (e.g., a DRx chain) (lower graphs b, d, f) in a single downlink pipe in an apparatus (e.g., a user equipment) operating in an MSIM mode according to some aspects of the disclosure. In FIG. 11, gear shifting associated with the first receiver chain may occur in connection with the second receiver chain changing state from OFF to ON. In FIG. 12, gear shifting associated with the first receiver chain may occur in connection with the second receiver chain changing state from ON to OFF. The first receiver chain is associated with a first subscriber (Sub1) and the second receiver chain is associated with a second subscriber (Sub2). Time is shown on the horizontal axes in units of μs×10⁴ and output voltage is shown on the vertical axes in units of mV. Vertical and/or horizontal axis identification has been removed from some graphs to avoid cluttering the drawings. In the examples of FIG. 11 and FIG. 12, numerology 1 is utilized, where each slot is 0.5 ms (500 μs) and there are 14 symbols per slot. Sub1 traffic is present throughout the duration of each of FIGS. 11a, 11c, 11c, 12a, 12c, and 12e. Sub2 traffic (different from Sub1 traffic) is present at the beginnings and ends of the durations of FIGS. 11b, 11d, 11f, 12b, 12d, and 12f; however, in the middle of the durations, for one slot (duration 500 μs), the second receiver chain is OFF (and Sub2 is presumed to be idle). Three examples in each of FIG. 11 and FIG. 12 are illustrated as the pairs of graphs labeled a and b, c and d, and e and f.

FIG. 11 and FIG. 12 exemplify an application of gear shifting in connection with the first subscription (Sub1) signal associated with the first receiver chain (e.g., the PRx chain) of a downlink pipe in response to the toggling (i.e., the change of state) of the second receiver chain (e.g., the DRx chain) of the downlink pipe. A second subscription (Sub2) signal is associated with the second receiver chain. The gear shifting may be implemented in connection with a tracking of a difference in timing between the Sub1 and Sub2 slot boundaries. The timing between slot boundaries illustrated in FIG. 11 and FIG. 12 is exemplary and not intended to be limiting. In some examples, the tracking of the difference in timing may be performed by a slot/symbol boundary and timing tracking circuit (similar to the slot/symbol boundary and timing tracking circuit 880 as shown and described in connection with FIG. 8). In other examples, the tracking of the difference in timing may be performed by one or more other circuits, for example, in the processing system of the apparatus.

In the examples of FIG. 11 and FIG. 12, the one or more processors of the apparatus employing a single downlink pipe in an MSIM mode may obtain the knowledge of the Sub1 and Sub2 slot boundaries. Using this knowledge, the one or more processors may configure gear shifting to a DC notch filter of a DC estimator circuit (similar to the first DC filter 842 and the first DC estimator 841 as shown and described in connection with FIG. 8) associated with the first receiver chain (i.e., the non-toggling receiver chain) according to some aspects of the disclosure. The one or more processors may implement the gear shifting (i.e., the temporary changing of a bandwidth of the DC notch filter from a first bandwidth to a second bandwidth, wider than the first bandwidth, and reversion of the bandwidth from the second bandwidth back to the first bandwidth) at predetermined times relative to the known slot boundaries. In some examples, the application of gear shifting may be in response to the toggling of the second receiver chain, which may cause an undesired DC shift in the analog IQ output of the first receiver chain (the non-toggled receiver chain). In some examples, the toggling of the second receiver chain may cause a change to the load of a local oscillator power supply, which in turn may cause the undesired DC shift in the analog IQ output of the first receiver chain (the non-toggled receiver chain). As stated above, the gear shifting may reduce a number (i.e., a quantity) of the symbols adversely impacted by the undesired DC shift (adversely impacted, for example, by a reduction in the signal-to-noise ratio of the adversely impacted symbols). Reducing the number of adversely impacted symbols improves the overall signal-to-noise ratio observed on the IQ lines of the non-toggling receiver chain during, or in response to, the toggling of the other receiver chain in the single downlink pipe.

In the first example, utilizing FIGS. 11a and 11b, and FIGS. 12a and 12b, the first slot boundary of the Sub1 signal associated with the first receiver chain and the second slot boundary of the Sub2 signal associated with the second receiver chain are aligned. In this first example, reference numerals 1101 (FIG. 11) and 1201 (FIG. 12) identify the times where gear shifting (GS) is applied. In the second example, utilizing FIGS. 11c and 11d, and FIGS. 12c and 12d, the second slot boundary of the Sub2 signal is ahead of (i.e., leads, precedes) the first slot boundary of the Sub1 signal. In this second example, the time to change the state of the second receiver chain from OFF to ON (in FIG. 11) or from ON to OFF (in FIG. 12) is delayed so that the change of state (turning on/off) aligns with the slot boundary of the Sub1 signal. Reference numerals 1102 (FIG. 11) and 1202 (FIG. 12) identify the times where gear shifting (GS) is applied. By way of example, the signal-to-noise ratio of the symbols of the Sub1 signal to the right of the application of gear shifting is recovered. In the third example, utilizing FIGS. 11e and 11f, and FIGS. 12c and 12f, the first slot boundary of the Sub1 signal is ahead of (i.e., leads, precedes) the second slot boundary of the Sub2 signal. In this third example, the time to change the state of the second receiver chain from OFF to ON (in FIG. 11) or ON to OFF (in FIG. 12) is advanced so that the change of state (turning on/off) aligns with the slot boundary of the Sub1 signal. Reference numerals 1103 (FIG. 11) and 1203 (FIG. 12) identify the times where gear shifting (GS) is applied. By way of example, the signal-to-noise ratio of the symbols of the Sub1 signal to the right of the application of gear shifting is recovered.

According to some aspects, the examples of FIGS. 11 and 12 may be used to describe a method operational at a wireless apparatus that may include an MSIM. For example, the method may include receiving, in a multi-subscriber identity module mode, a first signal associated with a first subscription (Sub1) at a first receiver chain of a two receiver chain downlink pipe, the first signal conveyed in a first plurality of slots, and receiving, in the multi-subscriber identity module mode, a second signal associated with a second subscription (Sub2) at a second receiver chain of the two receiver chain downlink pipe, the second signal conveyed in a second plurality of slots. The method may include tracking a first timing of a Sub1 slot boundary and a Sub2 slot boundary, and adjusting a second timing of a change of state of the second receiver chain from coinciding with the Sub2 slot boundary to coinciding with the Sub1 slot boundary. In some examples, the tracking a first timing of a Sub1 slot boundary and a Sub2 slot boundary and the adjusting a second timing of a change of a state of the second receiver chain (e.g., from coinciding with the Sub2 slot boundary to coinciding with the Sub1 slot boundary), may occur before configuring a circuit to change the state of the second receiver chain. For example, the tracking and the adjusting may precede a final write to hardware circuits associated with timing control of the changes of state (e.g., timing control of the changes of state between on and off and off and on). The method may further include temporarily increasing a first bandwidth of a DC notch filter associated with a DC estimator of the first receiver chain to a second bandwidth at a same time as the Sub1 slot boundary.

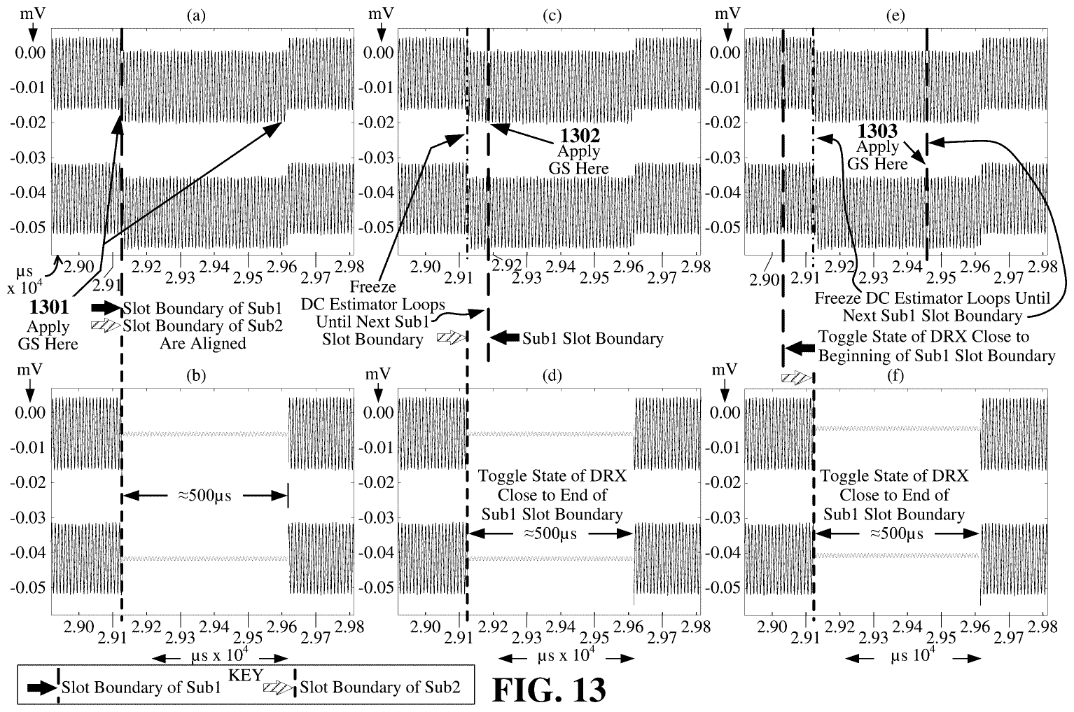

FIG. 13 presents a series of graphs illustrating the timing of an application of gear shifting to a first receiver chain of a downlink pipe in an apparatus according to some aspects of the disclosure. In the example of FIG. 13, the DC estimator loops (e.g., multiple DC estimator loops 840, 850, 860, 870 as shown and described in connection with FIG. 8) of the first receiver chain are frozen (i.e., stopped without resetting) at the time of the toggling of the second receiver chain and unfrozen (i.e., started without resetting, re-started without resetting) along with an application of gear shifting in association with the first receiver chain, at the time of the next Sub1 slot boundary.

As described in more detail below, examples herein utilize the knowledge of the slot boundaries of both the first subscription (Sub1) and the second subscription (Sub2) signals and employ gear shifting to mitigate the DC impairment to the analog IQ outputs of a first receiver chain of a single downlink pipe resulting from a change of state (e.g., a toggling from ON to OFF or OFF to ON) of a second receiver chain of the single downlink pipe. In the examples, an apparatus utilizes the single downlink pipe in an MSIM mode. In some examples, the knowledge of the slot boundaries of both the first subscription (Sub1) and the second subscription (Sub2) signals may be referred to as “Cross-Sub knowledge.”

FIG. 13 depicts examples of the analog IQ channel outputs of first and second receiver chains (e.g., the PRx and DRx chains, respectively), where FIGS. 13a, 13c, and 13e correspond to the I (top) and Q (bottom) channels of the first receiver chain and FIGS. 13b, 13d, and 13f correspond to the I (top) and Q (bottom) channels of the second receiver chain. In FIG. 13, time is shown on the horizontal axis in units of μs×10⁴ and output voltage is shown on the vertical axis in units of mV. Vertical and/or horizontal axis identification has been removed from some graphs to avoid cluttering the drawings. In the example of FIG. 13, numerology 1 is utilized, where each slot is 0.5 ms (500 μs) and there are 14 symbols per slot. Sub1 traffic is present throughout the duration of each of FIGS. 13a, 13c, and 13c. Sub2 traffic (different from Sub1 traffic) is present at the beginnings and ends of the durations of FIGS. 13b, 13d, and 13f; however, in the middle of the durations, for one slot (duration 500 μs), the second receiver chain is OFF (and Sub2 is presumed to be idle).

FIG. 13 exemplifies an application of gear shifting in connection with the first subscription (Sub1) signal associated with the first receiver chain (e.g., the PRx chain) of a downlink pipe in association with the toggling (i.e., the change of state) of the second receiver chain (e.g., the DRx chain) of the downlink pipe. The gear shifting may be implemented in connection with a tracking of a difference in timing between the first subscription (Sub1) and a second subscription (Sub2) slot boundaries. The timing between slot boundaries illustrated in FIG. 13 is exemplary and not intended to be limiting. In some examples, the tracking of the difference in timing may be performed by a slot/symbol boundary and timing tracking circuit (similar to the slot/symbol boundary and timing tracking circuit 880 as shown and described in connection with FIG. 8). In other examples, the tracking of the difference in timing may be performed by one or more other circuits in the processing system of the apparatus.

In the example of FIG. 13, the one or more processors of the apparatus employing a single downlink pipe in an MSIM mode may obtain the knowledge of the Sub1 and Sub2 slot boundaries. Using this knowledge, the one or more processors of the apparatus may freeze (i.e., stop without resetting) an operation of the DC estimator loops (similar to the multiple DC estimator loops 840, 850, 860, 870 as shown and described in connection with FIG. 8) associated with the first receiver chain (i.e., the non-toggling receiver chain) at a time of toggling the second receiver chain and unfreeze (i.e., start without resetting, re-start without resetting) the DC estimator loops at a time of a next Sub1 slot boundary. Additionally, at the time of the same Sub1 slot boundary, the one or more processors may configure gear shifting to a DC notch filter of a DC estimator circuit (similar to the first DC filter 842 and the first DC estimator 841 as shown and described in connection with FIG. 8) associated with the first receiver chain (i.e., the non-toggling receiver chain) according to some aspects of the disclosure. The one or more processors may implement the gear shifting (i.e., the temporary changing of a bandwidth of the DC notch filter from a first bandwidth to a second bandwidth, wider than the first bandwidth, and reversion of the bandwidth from the second bandwidth back to the first bandwidth) at predetermined times relative to the known slot boundaries. In some examples, the application of gear shifting may be in association with (or in response to) the toggling of the second receiver chain. The toggling of the second receiver chain may cause an undesired DC shift in the analog IQ outputs of the first receiver chain (i.e., the non-toggled receiver chain). The toggling of the second receiver chain may cause a change to a load current of a local oscillator distribution network, or a local oscillator power supply, which in turn may cause the undesired DC shift in the analog IQ outputs of the first receiver chain (the non-toggled receiver chain). As stated above, the gear shifting may reduce a number (i.e., a quantity) of the symbols adversely impacted by the undesired DC shift (adversely impacted, for example, by a reduction in the signal-to-noise ratio of the adversely impacted symbols). Reducing the number of adversely impacted symbols improves the overall signal-to-noise ratio observed on the IQ lines of the non-toggling receiver chain during, or in response to, the toggling of the other receiver chain in the single downlink pipe (e.g., of the apparatus operating in an MSIM mode).

Three examples of slot boundary relationships are depicted in FIG. 13. In the first example, utilizing FIGS. 13a and 13b, the first slot boundary of the Sub1 signal served by the first receiver chain and the second slot boundary of the Sub2 signal served by the second receiver chain are aligned. In this first example, reference numeral 1301 identifies the points in time where gear shifting (GS) is applied. In the second example, utilizing FIGS. 13c and 13d, the second slot boundary of the Sub2 signal served by the second receiver chain is ahead of (i.e., leads, precedes) the first slot boundary of the Sub1 signal served by the first receiver chain. In this second example, reference numeral 1302 identifies the point in time where gear shifting (GS) is applied. In the third example, utilizing FIGS. 13e and 13f, the first slot boundary of the Sub1 signal served by the first receiver chain is ahead of (i.e., leads, precedes) the second slot boundary of the Sub2 signal served by the second receiver chain. In this third example, reference numeral 1303 identifies the point in time where gear shifting (GS) is applied.

According to some aspects, the examples of FIG. 13 may be used to describe a method operational at a wireless apparatus that may include a multi-subscriber identity module. For example the method may include, receiving a first signal associated with a first subscription at a first receiver chain of a two receiver chain downlink pipe, the first signal conveyed in a first plurality of slots, receiving a second signal associated with a second subscription at a second receiver chain of the two receiver chain downlink pipe, the second signal conveyed in a second plurality of slots, and changing a state of the second receiver chain between an on state and an off state at a first time. The method may also include stopping, without resetting, at the first time, an iteration of (direct current) DC estimator loops associated with the first receiver chain, starting, without resetting, at a first slot boundary of the first plurality of slots occurring subsequent to the stopping, the iteration of the DC estimator loops associated with the first receiver chain. The method may also include temporarily increasing a first bandwidth of a DC notch filter associated with a DC estimator of the first receiver chain to a second bandwidth at a same time as the starting.

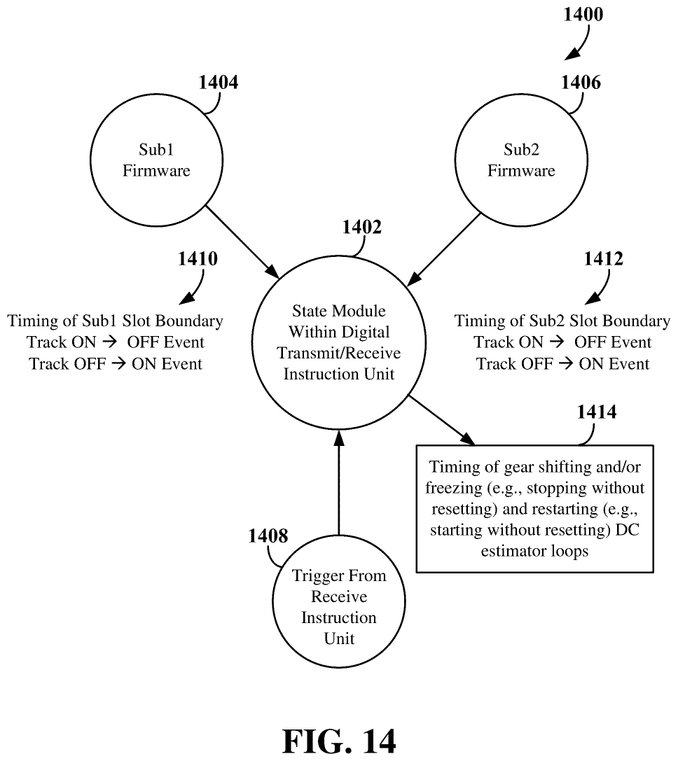

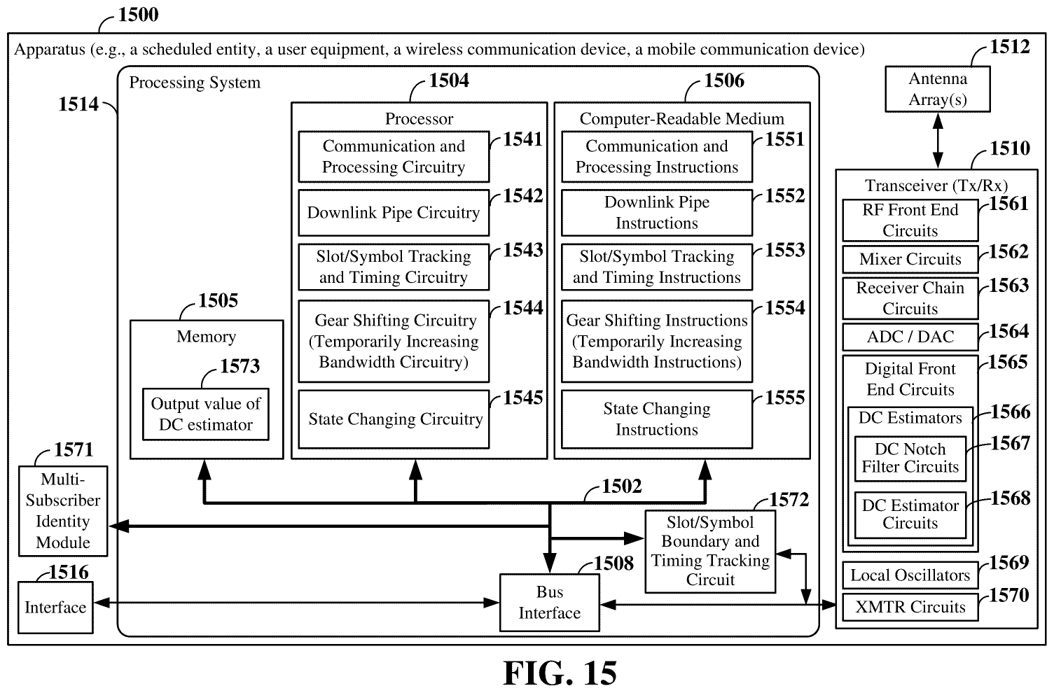

FIG. 14 is a diagram associated with a state module circuit 1400 according to some aspects of the disclosure. FIG. 14 depicts a state module 1402 (e.g., a slot/symbol boundary and timing tracking circuit as shown and described in connection with FIG. 8) within a digital transmit/receive instruction unit (e.g., a component of a processing system similar to the processing system 1514 as shown and described in connection with FIG. 15, below). The state module 1402 may receive input from Sub1 firmware 1404 and Sub2 firmware 1406. The state module circuit 1400 may receive a trigger 1408 from a receive instruction unit (e.g., a component of a processing system similar to the processing system 1514 as shown and described in connection with FIG. 15, below). The state module 1402 may keep track of timing of Sub1 slot boundaries 1410, for example, by tracking on to off and off to on events. The state module 1402 may keep track of timing of Sub2 slot boundaries 1412, for example, by tracking on to off and off to on events. The state module 1402 may output commands associated with timing of gear shifting (e.g., temporary changes to the bandwidth of a given filter) and/or freezing (e.g., stopping without resetting) and restarting (e.g., starting without resetting) DC estimator loops. The state module 1402 may perform other functionality described throughout this disclosure.

FIG. 15 is a block diagram illustrating an example of a hardware implementation of an apparatus 1500 (e.g., a scheduled entity, a user equipment, a wireless communication device, a mobile communication device) employing one or more processing systems (generally represented by processing system 1514) according to some aspects of the disclosure. The apparatus 1500 may be similar to, for example, any of the scheduled entities, user equipment, wireless communication devices, and mobile communication devices, or part thereof, as shown and described in connection with FIGS. 1, 2, and 8.

In accordance with various aspects of the disclosure, an element, any portion of an element, or any combination of elements may be implemented with a processing system 1514 that includes one or more processors, generally represented by processor 1504. Examples of processor 1504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the apparatus 1500 may be configured to perform any one or more of the functions described herein. That is, the one or more processors (generally represented by processor 1504), as utilized in the apparatus 1500, may be configured to, individually or collectively, implement any one or more of the methods or processes that may be described in connection with, for example, any of FIGS. 4-14.

In this example, the processing system 1514 may be implemented with a bus architecture, represented generally by the bus 1502. The bus 1502 may include any number of interconnecting buses and bridges depending on the specific application of the processing system 1514 and the overall design constraints. The bus 1502 communicatively couples together various circuits, including one or more processors (represented generally by the processor 1504), one or more memories (represented generally by a memory 1505), and one or more computer-readable media (represented generally by the computer-readable medium 1506), a multi-subscriber identity module 1571, and a slot/symbol boundary and timing tracking circuit 1572. The bus 1502 may also link various other circuits such as timing sources, peripherals, voltage regulators, and power management circuits, which are well known to persons having ordinary skill in the art and, therefore, will not be described any further. The slot/symbol boundary and timing tracking circuit 1572 may additionally or alternatively be coupled to the bus interface 1508.

A bus interface 1508 provides an interface between the bus 1502 and a transceiver 1510. The transceiver 1510 may be, for example, a wireless transceiver. The transceiver 1510 may be operational with multiple RATs (e.g., LTE, 5G NR, IEEE 1502.11 (WiFi®), etc.). The transceiver 1510 may provide respective means for communicating with various other apparatus, UEs, and core networks over a transmission medium (e.g., air interface).

The transceiver 1510 may be the same or similar to the transceiver 800 as shown and described in connection with FIG. 8. For example, the transceiver may include RF front end circuits 1561, similar to the RFFE 822 as shown and described in connection with FIG. 8. The transceiver 1510 may include mixer circuits 1562, similar to the first mixer 826 and the second mixer 827 as shown and described in connection with FIG. 8. The transceiver 1510 may include baseband filters, similar to the first baseband filter 856 and the second baseband filter 857 as shown and described in connection with FIG. 8. The transceiver 1510 may include analog-to-digital converter (ADC) and digital-to-analog converter (DAC) circuits (ADC/DAC) 1564, similar to the first ADC 828, the second ADC 829, and the DAC 814 as shown and described in connection with FIG. 8. Still further, the transceiver 1510 may include a digital front end circuit 1565, similar to the digital front end 824 as shown and described in connection with FIG. 8. The digital front end circuit 1565 may include a plurality of DC estimator circuits 1566, including DC notch filter circuits 1567 and DC estimator circuits 1568, similar to the plurality of DC estimators 841, 851, 861, 871, the plurality of DC filters 842, 852, 862, 872 (i.e., DC notch filters), and the plurality of DC estimator circuits 843, 853, 863, 873, all as shown and described in connection with FIG. 8. The transceiver may also include local oscillators 1569 (or synthesizer(s)) similar to the first local oscillator 806 and the second local oscillator 808 (as well as a local oscillator distribution network 858) all as shown and described in connection with FIG. 8. Still further, the transceiver may include transmitter circuits 1570, similar to the transmitter circuitry 812, 814, 816, 818, 820 all as shown and described in connection with FIG. 8. The slot/symbol boundary and timing tracking circuit 1572 may additionally or alternatively be coupled to the bus interface 1508 and to the transceiver 1510 and its components (e.g., the DC notch filter circuits 1567) via the bus interface 1508 or via another coupling.

The transceiver 1510 may be coupled to one or more antenna array(s) 1512, such as the antennas/antenna arrays 802a, 802b, 802c as shown and described in connection with FIG. 8. The bus interface 1508 may provide an interface between the bus 1502 and a user interface 1516 (e.g., keypad, display, touch screen, speaker, microphone, control features, vibration circuit/device, etc.). The user interface 1516 is optional and may be omitted in some examples.

One or more processors, represented individually and collectively by processor 1504, may be responsible for managing the bus 1502 and general processing, including the execution of software stored on the computer-readable medium 1506. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 1506. The software, when executed by the processor 1504, causes the processing system 1514 to perform the various processes and functions described herein for any particular apparatus.

The computer-readable medium 1506 may be a non-transitory computer-readable medium and may be referred to as a computer-readable storage medium or a non-transitory computer-readable medium. The non-transitory computer-readable medium may store computer-executable code (e.g., processor-executable code). The computer executable code may include code for causing a computer (e.g., a processor) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1506 may reside in the processing system 1514, external to the processing system 1514, or distributed across multiple entities, including the processing system 1514. The computer-readable medium 1506 may be embodied in a computer program product or article of manufacture. By way of example, a computer program product or article of manufacture may include a computer-readable medium in packaging materials. In some examples, the computer-readable medium 1506 may be part of the memory 1505. Persons having ordinary skill in the art will recognize how best to implement the described functionality presented throughout this disclosure depending on the particular application and the overall design constraints imposed on the overall system. The computer-readable medium 1506 and/or the memory 1505 may also be used for storing data that is manipulated by the processor 1504 when executing software. For example, the output value of DC estimator storage 1573 of the memory 1505 may be utilized in connection with storing a first output value of the DC estimator during an on state of the first receiver chain and the second receiver chain, and utilizing the first output value as an initial seed value applied to the DC estimator in conjunction with the temporarily increasing the first bandwidth to the second bandwidth.

In some aspects of the disclosure, the processor 1504 may include communication and processing circuitry 1541 configured for various functions, including, for example, communicating with a network entity (e.g., a scheduling entity, a base station, an aggregated or disaggregated base station, an eNB, a gNB, a TRP), another apparatus, and/or a core network. In some examples, the communication and processing circuitry 1541 may include one or more hardware components that provide the physical structure that performs processes related to wireless communication (e.g., signal reception and/or signal transmission) and signal processing (e.g., processing a received signal and/or processing a signal for transmission). The communication and processing circuitry 1541 configured for various other functions, including, for example, storing a first output value of the DC estimator during an on state of the first receiver chain and the second receiver chain, and utilizing the first output value as an initial seed value applied to the DC estimator in conjunction with the temporarily increasing the first bandwidth to the second bandwidth. The communication and processing circuitry 1541 configured for various other functions, including, for example, stopping, without resetting, at the first time, an iteration of DC estimator loops associated with the first receiver chain, starting, without resetting, at a first slot boundary of the first plurality of slots occurring subsequent to the stopping, the iteration of the DC estimator loops associated with the first receiver chain, and temporarily increasing a first bandwidth of a DC notch filter associated with a DC estimator of the first receiver chain to a second bandwidth at a same time as the starting. The communication and processing circuitry 1541 may further be configured to execute communication and processing instructions 1551 (e.g., software) stored on the computer-readable medium 1506 to implement one or more functions described herein.

In some aspects of the disclosure, the processor 1504 may include downlink pipe circuitry 1542 configured for various functions, including, for example, receiving, in a multi-subscriber identity module mode, a first signal associated with a first subscription at a first receiver chain (e.g., a PRx chain) of a two receiver chain downlink pipe, the first signal conveyed in a first plurality of slots and receiving, in the multi-subscriber identity module mode, a second signal associated with a second subscription at a second receiver chain (e.g., a DRx chain) of the two receiver chain downlink pipe, the second signal conveyed in a second plurality of slots. According to some aspects, the two receiver chain downlink pipe may be a sole downlink pipe of the apparatus.

In some examples the downlink pipe circuitry 1542 may be configured for additional functions, including, for example, and in response to the apparatus being reconfigured to operate in single subscriber identity module mode, the downlink pipe circuitry 1542 may be configured to receive the first signal at the first receiver chain of the two receiver chain downlink pipe, and receive the first signal at the second receiver chain of the two receiver chain downlink pipe, the second receiver chain serving as a diversity receiver chain. The downlink pipe circuitry 1542 may further be configured to execute downlink pipe instructions 1552 (e.g., software) stored on the computer-readable medium 1506 to implement one or more functions described herein.

In some aspects of the disclosure, the processor 1504 may include slot/symbol tracking and timing circuitry 1543, which may be similar to or may be used as an alternative to the slot/symbol boundary and timing tracking circuit 1572. The slot/symbol tracking and timing circuitry 1543 may be configured for various functions, including, for example, tracking a difference in timing of a first slot boundary of the first plurality of slots and a second slot boundary of the second plurality of slots. The slot/symbol tracking and timing circuitry 1543 may be configured for various other functions, including, for example, tracking a timing of a Sub1 slot boundary and a Sub2 slot boundary, and adjusting a timing of a change of a state of the second receiver chain from coinciding with the Sub2 slot boundary to coinciding with the Sub1 slot boundary. In some examples, in response to the Sub1 slot boundary being ahead of the Sub2 slot boundary, the timing of the change of the state of the second receiver chain may be advanced from coinciding with the Sub2 slot boundary to coinciding with the Sub1 slot boundary, and in response to the Sub2 slot boundary being ahead of the Sub1 slot boundary, the timing of the change of the state of the second receiver chain may be delayed from coinciding with the Sub2 slot boundary to coinciding with the Sub1 slot boundary. The slot/symbol tracking and timing circuitry 1543 may be configured for various other functions, including, for example, configuring a timing control hardware circuit (e.g., of the slot/symbol tracking and timing circuitry 1543 and/or of the slot/symbol boundary and timing tracking circuit 1572) to change the state of the second receiver chain (e.g., to cause an adjustment of the second timing of the change of the state of the second receiver chain) in response to determining whether the Sub1 slot boundary is ahead of or delayed from the Sub2 slot boundary. The slot/symbol tracking and timing circuitry 1543 may further be configured to execute downlink pipe instructions 1553 (e.g., software) stored on the computer-readable medium 1506 to implement one or more functions described herein.

In some aspects of the disclosure, the processor 1504 may include gear shifting circuitry (temporarily increasing bandwidth circuitry) 1544 configured for various functions, including, for example, in response to a change of a state of the second receiver chain, one of: temporarily increasing, at a same time as the first slot boundary, a first bandwidth of a direct current (DC) notch filter associated with a DC estimator of the first receiver chain to a second bandwidth, in response to the first slot boundary and the second slot boundary coinciding; temporarily increasing, prior to the first slot boundary, the first bandwidth to the second bandwidth, in response to the second slot boundary being advanced in time relative to the first slot boundary; or temporarily increasing, subsequent to the first slot boundary, the first bandwidth to the second bandwidth, in response to the second slot boundary being delayed in time relative to the first slot boundary. In some examples, the gear shifting circuitry 1544 may be configure for other various functions including, for example, reverting the second bandwidth to the first bandwidth, narrower than the second bandwidth, after a predetermined number of symbols associated with the first signal. In some examples the predetermined number of symbols is between one and three symbols, inclusive, in other examples the predetermined number of symbols is two symbols.

According to some aspects, a DC shift of the first signal at an analog output of the first receiver chain occurs in response to the change of the state of the second receiver chain, and the temporarily increasing the first bandwidth to the second bandwidth reduces a time it takes the DC estimator to settle toward a final estimated DC value of the first signal after the DC shift in comparison to the time it would take to settle toward the final estimated DC value without temporarily increasing the first bandwidth to the second bandwidth. The gear shifting circuitry (temporarily increasing bandwidth circuitry) 1544 may be configured for various other functions, including, for example, temporarily increasing, at a same time as the change of the state of the second receiver chain, a first bandwidth of a DC notch filter associated with a DC estimator of the first receiver chain to a second bandwidth. The gear shifting circuitry (temporarily increasing bandwidth circuitry) 1544 may be configured for various other functions, including, for example, temporarily increasing, at a same time as the Sub1 slot boundary, a first bandwidth of a DC notch filter associated with a DC estimator of the first receiver chain to a second bandwidth. The gear shifting circuitry (temporarily increasing bandwidth circuitry) 1544 may further be configured to execute gear shifting (temporarily increasing bandwidth) instructions 1554 (e.g., software) stored on the computer-readable medium 1506 to implement one or more functions described herein.

In some aspects of the disclosure, the processor 1504 may include state changing circuitry 1545 configured for various functions, including, for example, changing a state of the second receiver chain between an on state and an off state (e.g., at a predetermined time, at a first time). The change of the state may be from an on state to an off state, or from the off state to the on state. In some examples, the change of the state occurs with a change of a load current of a local oscillator distribution network providing a local oscillator signal to the second receiver chain, and the change of the load current causes a DC shift of the first signal at an analog output of the first receiver chain. The state changing circuitry 1545 may further be configured to execute state changing instructions 1555 (e.g., software) stored on the computer-readable medium 1506 to implement one or more functions described herein.

In general, an apparatus, such as the apparatus 1500, may include one or more memories (e.g., represented by memory 1505), and one or more processors (e.g., represented by processor 1504), the one or more processors may be configured to, individually or collectively, based at least in part on information stored in the one or more memories: perform any of the processes described herein.

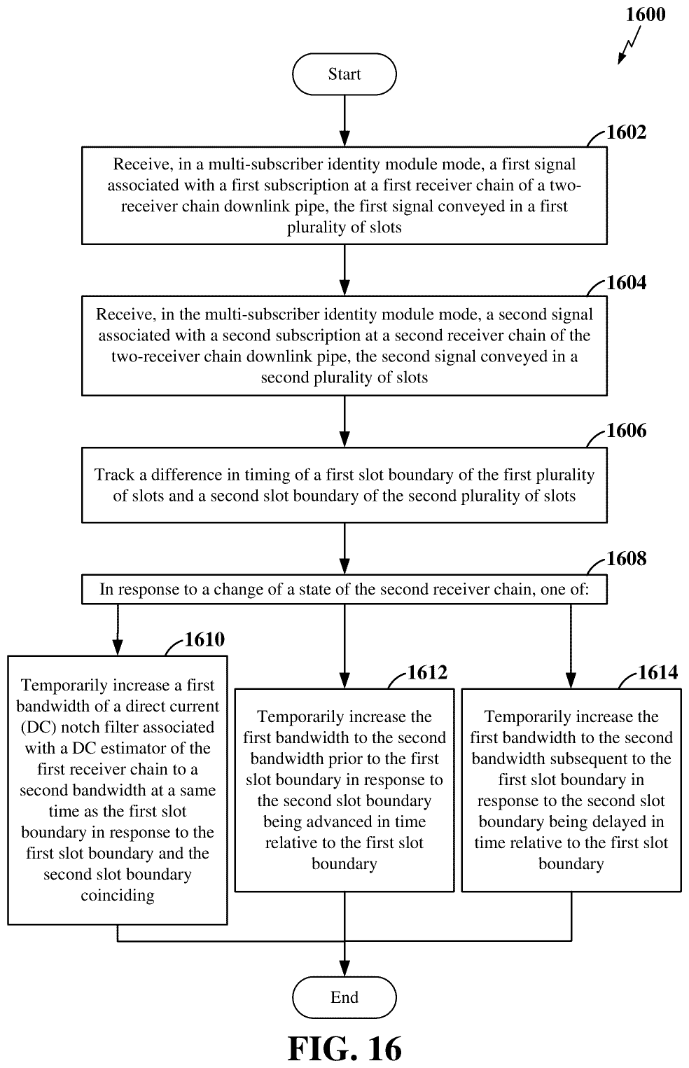

FIG. 16 is a flow chart illustrating an example process 1600 (e.g., a method) of wireless communication at an apparatus (e.g., a scheduled entity, a user equipment, a wireless communications device, a mobile communication device) according to some aspects of the disclosure. As described below, some or all illustrated features may be omitted in a particular implementation within the scope of the present disclosure, and some illustrated features may not be required for the implementation of all examples. In some examples, the process 1600 may be carried out by the apparatus 1500, as shown and described in connection with FIG. 15. The apparatus 1500 may be similar to, for example, any of the scheduled entities, user equipment, wireless communications devices, and/or mobile communication devices of FIGS. 1 and 2. In some examples, the process 1600 may be carried out by any suitable apparatus or means for carrying out the functions or algorithm described below.

At block 1602, the apparatus may receive, in a multi-subscriber identity module mode, a first signal associated with a first subscription at a first receiver chain of a two receiver chain downlink pipe, the first signal conveyed in a first plurality of slots. For example, the communication and processing circuitry 1541, in combination with the downlink pipe circuitry 1542, as shown and described in connection with FIG. 15, may provide a means for receiving, in a multi-subscriber identity module mode, a first signal associated with a first subscription at a first receiver chain of a two receiver chain downlink pipe, the first signal conveyed in a first plurality of slots. According to some aspects, the two receiver chain downlink pipe may be a sole downlink pipe of the apparatus.

At block 1604, the apparatus may receive, in the multi-subscriber identity module mode, a second signal associated with a second subscription at a second receiver chain of the two receiver chain downlink pipe, the second signal conveyed in a second plurality of slots. For example, the communication and processing circuitry 1541, in combination with the downlink pipe circuitry 1542, as shown and described in connection with FIG. 15, may provide a means for receiving in the multi-subscriber identity module mode, a second signal associated with a second subscription at a second receiver chain of the two receiver chain downlink pipe, the second signal conveyed in a second plurality of slots.

At block 1606, the apparatus may track a difference in timing of a first slot boundary of the first plurality of slots and a second slot boundary of the second plurality of slots. For example, the slot/symbol tracking and timing circuitry 1543 and/or the slot/symbol boundary and timing tracking circuit 1572, as shown and described in connection with FIG. 15, may provide a means for tracking a difference in timing of a first slot boundary of the first plurality of slots and a second slot boundary of the second plurality of slots.

At block 1608, the apparatus may, in response to a change of a state of the second receiver chain, proceed to any one of blocks 1610, 1612, or 1614. For example, the change of state may be from an on state to an off state, or the off state to the on state. For example, the state changing circuitry 1545, as shown and described in connection with FIG. 15, may provide a means for the changing of a state of the second receiver chain. According to some aspects, the change of the state occurs with a change of a load current of a local oscillator distribution network providing a local oscillator signal to the second receiver chain, and the change of the load current causes a DC shift of the first signal at an analog output of the first receiver chain.

At block 1610, the apparatus may temporarily increase a first bandwidth of a direct current (DC) notch filter associated with a DC estimator of the first receiver chain to a second bandwidth at a same time as the first slot boundary in response to the first slot boundary and the second slot boundary coinciding. For example, the second bandwidth may revert to the first bandwidth, narrower than the second bandwidth, after a predetermined number of symbols associated with the first signal. In some examples, the predetermined number of symbols may be between one and three symbols, inclusive. In some examples, the predetermined number may be 2 symbols. For example, the gear shifting circuitry 1544 as shown and described in connection with FIG. 15, may provide a means for temporarily increasing a first bandwidth of a direct current (DC) notch filter associated with a DC estimator of the first receiver chain to a second bandwidth at a same time as the first slot boundary in response to the first slot boundary and the second slot boundary coinciding. The gear shifting circuitry 1544 may also provide a means for reverting the second bandwidth to the first bandwidth, narrower than the second bandwidth, after a predetermined number of symbols associated with the first signal.

At block 1612, the apparatus may temporarily increase the first bandwidth to the second bandwidth prior to the first slot boundary in response to the second slot boundary being advanced in time relative to the first slot boundary. For example, the second bandwidth may revert to the first bandwidth, narrower than the second bandwidth, after a predetermined number of symbols associated with the first signal. In some examples, the predetermined number of symbols may be between one and three symbols, inclusive. In some examples, the predetermined number may be 2 symbols. For example, the gear shifting circuitry 1544 as shown and described in connection with FIG. 15, may provide a means for temporarily increasing a first bandwidth of a direct current (DC) notch filter associated with a DC estimator of the first receiver chain to a second bandwidth in response to the second slot boundary being advanced in time relative to the first slot boundary. The gear shifting circuitry 1544 may also provide a means for reverting the second bandwidth to the first bandwidth, narrower than the second bandwidth, after a predetermined number of symbols associated with the first signal.

At block 1614, the apparatus may temporarily increase the first bandwidth to the second bandwidth subsequent to the first slot boundary in response to the second slot boundary being delayed in time relative to the first slot boundary. For example, the second bandwidth may revert to the first bandwidth, narrower than the second bandwidth, after a predetermined number of symbols associated with the first signal. In some examples, the predetermined number of symbols may be between one and three symbols, inclusive. In some examples, the predetermined number may be 2 symbols. For example, the gear shifting circuitry 1544 as shown and described in connection with FIG. 15, may provide a means for temporarily increasing a first bandwidth of a direct current (DC) notch filter associated with a DC estimator of the first receiver chain to a second bandwidth in response to the second slot boundary being delayed in time relative to the first slot boundary. The gear shifting circuitry 1544 may also provide a means for reverting the second bandwidth to the first bandwidth, narrower than the second bandwidth, after a predetermined number of symbols associated with the first signal.

In connection with at least blocks 1610, 1612, and 1614, a DC shift of the first signal at an analog output of the first receiver chain may occur in response to the change of the state of the second receiver chain, and the temporarily increasing the first bandwidth to the second bandwidth reduces a time it takes the DC estimator to settle toward a final estimated DC value of the first signal after the DC shift in comparison to the time it would take to settle toward the final estimated DC value without temporarily increasing the first bandwidth to the second bandwidth.

According to some aspects, the process 1600 may further include, in response to the apparatus being reconfigured to operate in a single subscriber identity module mode, receiving the first signal at the first receiver chain of the two receiver chain downlink pipe, and receiving the first signal at the second receiver chain of the two receiver chain downlink pipe, the second receiver chain serving as a diversity receiver chain. For example, the communication and processing circuitry 1541 as shown and described in connection with FIG. 15, may provide a means for receiving the first signal at the first receiver chain of the two receiver chain downlink pipe, and means for receiving the first signal at the second receiver chain of the two receiver chain downlink pipe, the second receiver chain serving as a diversity receiver chain.

According to some aspects, the process 1600 may further include, storing a first output value of the DC estimator during an on state of the first receiver chain and the second receiver chain, and utilizing the first output value as an initial seed value applied to the DC estimator in conjunction with the temporarily increasing the first bandwidth to the second bandwidth. For example, the communication and processing circuitry, in combination with the output value of DC estimator storage 1573, may provide a means for storing a first output value of the DC estimator during an on state of the first receiver chain and the second receiver chain, and utilizing the first output value as an initial seed value applied to the DC estimator in conjunction with the temporarily increasing the first bandwidth to the second bandwidth.

Thereafter, the process 1600 may end.

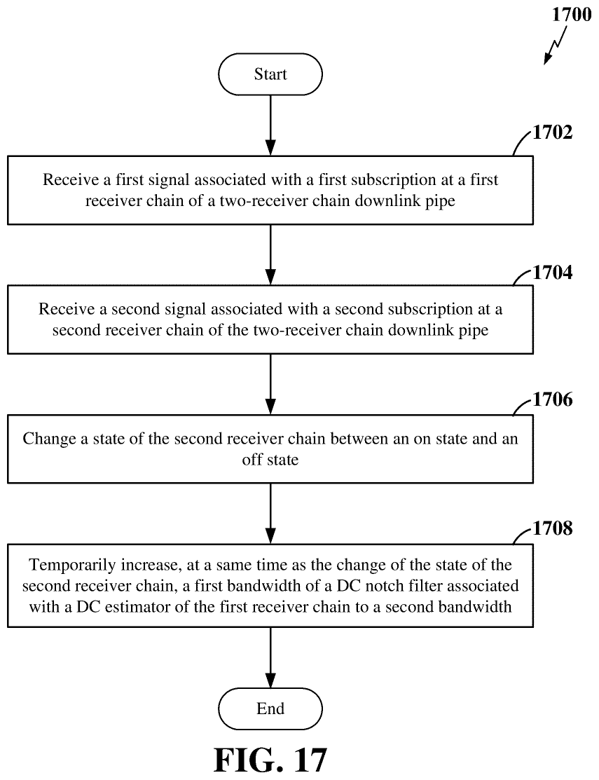

FIG. 17 is a flow chart illustrating an example process 1700 (e.g., a method) of wireless communication at an apparatus (e.g., a scheduled entity, a user equipment, a wireless communications device, a mobile communication device) according to some aspects of the disclosure. As described below, some or all illustrated features may be omitted in a particular implementation within the scope of the present disclosure, and some illustrated features may not be required for the implementation of all examples. In some examples, the process 1700 may be carried out by the apparatus 1500, as shown and described in connection with FIG. 15. The apparatus 1500 may be similar to, for example, any of the scheduled entities, user equipment, wireless communications devices, and/or mobile communication devices of FIGS. 1 and 2. In some examples, the process 1700 may be carried out by any suitable apparatus or means for carrying out the functions or algorithm described below.

At block 1702, the apparatus may receive a first signal associated with a first subscription at a first receiver chain of a two receiver chain downlink pipe. For example, the communication and processing circuitry 1541, in combination with the downlink pipe circuitry 1542, as shown and described in connection with FIG. 15, may provide a means for receiving a first signal associated with a first subscription at a first receiver chain of a two receiver chain downlink pipe. According to some aspects, the two receiver chain downlink pipe may be a sole downlink pipe of the apparatus.

At block 1704, the apparatus may receive a second signal associated with a second subscription at a second receiver chain of the two receiver chain downlink pipe. For example, the communication and processing circuitry 1541, in combination with the downlink pipe circuitry 1542, as shown and described in connection with FIG. 15, may provide a means for receiving a second signal associated with a second subscription at a second receiver chain of the two receiver chain downlink pipe.

At block 1706, the apparatus may change a state of the second receiver chain between an on state and an off state. For example, the change of state may be from an on state to an off state, or the off state to the on state. For example, the state changing circuitry 1545, as shown and described in connection with FIG. 15, may provide a means for the changing of a state of the second receiver chain. According to some aspects, the change of the state occurs with a change of a load current of a local oscillator distribution network providing a local oscillator signal to the second receiver chain, and the change of the load current causes a DC shift of the first signal at an analog output of the first receiver chain.

At block 1708, the apparatus may temporarily increase, at a same time as the change of the state of the second receiver chain, a first bandwidth of a DC notch filter associated with a DC estimator of the first receiver chain to a second bandwidth. For example, the second bandwidth may revert to the first bandwidth, narrower than the second bandwidth, after a predetermined number of symbols associated with the first signal. In some examples, the predetermined number of symbols may be between one and three symbols, inclusive. In some examples, the predetermined number may be 2 symbols. For example, the gear shifting circuitry 1544 as shown and described in connection with FIG. 15, may provide a means for temporarily increasing, at a same time as the changing the state of the second receiver chain, a first bandwidth of a DC notch filter associated with a DC estimator of the first receiver chain to a second bandwidth.

The gear shifting circuitry 1544 may also provide a means for reverting the second bandwidth to the first bandwidth, narrower than the second bandwidth, after a predetermined number of symbols associated with the first signal.

According to some aspects, a DC shift of the first signal at an analog output of the first receiver chain may occur in response to the change of the state of the second receiver chain, and the temporarily increasing the first bandwidth to the second bandwidth reduces a time it takes the DC estimator to settle toward a final estimated DC value of the first signal after the DC shift in comparison to the time it would take to settle toward the final estimated DC value without temporarily increasing the first bandwidth to the second bandwidth.

According to some aspects, the process 1700 may further include, in response to the apparatus being reconfigured to operate in a single subscriber identity module mode, receiving the first signal at the first receiver chain of the two receiver chain downlink pipe, and receiving the first signal at the second receiver chain of the two receiver chain downlink pipe, the second receiver chain serving as a diversity receiver chain. For example, the communication and processing circuitry 1541 as shown and described in connection with FIG. 15, may provide a means for receiving the first signal at the first receiver chain of the two receiver chain downlink pipe, the first signal conveyed in the first plurality of slots, and means for receiving the first signal at the second receiver chain of the two receiver chain downlink pipe, the second signal conveyed in the second plurality of slots, the second receiver chain serving as a diversity receiver chain.

According to some aspects, the process 1700 may further include, storing a first output value of the DC estimator during an on state of the first receiver chain and the second receiver chain, and utilizing the first output value as an initial seed value applied to the DC estimator in conjunction with the temporarily increasing the first bandwidth to the second bandwidth. For example, the communication and processing circuitry, in combination with the output value of DC estimator storage 1573, may provide a means for storing a first output value of the DC estimator during an on state of the first receiver chain and the second receiver chain, and utilizing the first output value as an initial seed value applied to the DC estimator in conjunction with the temporarily increasing the first bandwidth to the second bandwidth.

Thereafter, the process 1700 may end.

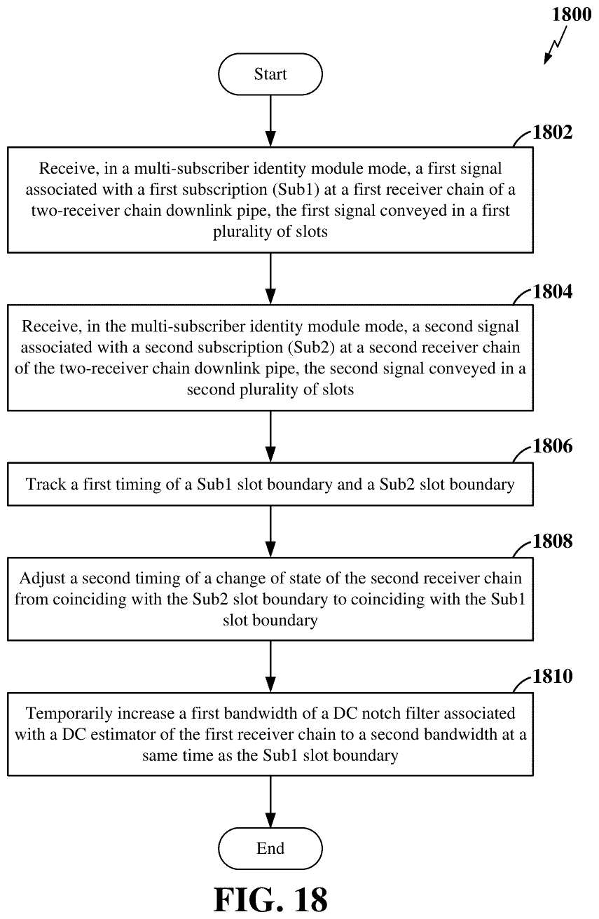

FIG. 18 is a flow chart illustrating an example process 1800 (e.g., a method) of wireless communication at an apparatus (e.g., a scheduled entity, a user equipment, a wireless communications device, a mobile communication device) according to some aspects of the disclosure. As described below, some or all illustrated features may be omitted in a particular implementation within the scope of the present disclosure, and some illustrated features may not be required for the implementation of all examples. In some examples, the process 1800 may be carried out by the apparatus 1500, as shown and described in connection with FIG. 15. The apparatus 1500 may be similar to, for example, any of the scheduled entities, user equipment, wireless communications devices, and/or mobile communication devices of FIGS. 1 and 2. In some examples, the process 1800 may be carried out by any suitable apparatus or means for carrying out the functions or algorithm described below.

At block 1802, the apparatus may receive, in a multi-subscriber identity module mode, a first signal associated with a first subscription (Sub1) at a first receiver chain of a two receiver chain downlink pipe, the first signal conveyed in a first plurality of slots. For example, the communication and processing circuitry 1541, in combination with the downlink pipe circuitry 1542, as shown and described in connection with FIG. 15, may provide a means for receiving, in a multi-subscriber identity module mode, a first signal associated with a first subscription (Sub1) at a first receiver chain of a two receiver chain downlink pipe, the first signal conveyed in a first plurality of slots. According to some aspects, the two receiver chain downlink pipe may be a sole downlink pipe of the apparatus.

At block 1804, the apparatus may receive, in the multi-subscriber identity module mode, a second signal associated with a second subscription (Sub2) at a second receiver chain of the two receiver chain downlink pipe, the second signal conveyed in a second plurality of slots. For example, the communication and processing circuitry 1541, in combination with the downlink pipe circuitry 1542, as shown and described in connection with FIG. 15, may provide a means for receiving, in the multi-subscriber identity module mode, a second signal associated with a second subscription (Sub2) at a second receiver chain of the two receiver chain downlink pipe, the second signal conveyed in a second plurality of slots.

At block 1806, the apparatus may track a first timing of a Sub1 slot boundary and a Sub2 slot boundary. For example, the slot/symbol tracking and timing circuitry 1543 and/or the slot/symbol boundary and timing tracking circuit 1572, as shown and described in connection with FIG. 15, may provide a means for tracking a first timing of a Sub1 slot boundary and a Sub2 slot boundary.

At block 1808, the apparatus may adjust a second timing of a change of state of the second receiver chain from coinciding with the Sub2 slot boundary to coinciding with the Sub1 slot boundary. For example, the slot/symbol tracking and timing circuitry 1543 and/or the slot/symbol boundary and timing tracking circuit 1572, as shown and described in connection with FIG. 15, may provide a means for adjusting a second timing of a change of state of the second receiver chain from coinciding with the Sub2 slot boundary to coinciding with the Sub1 slot boundary. In some examples, in response to the Sub1 slot boundary being ahead of the Sub2 slot boundary, the timing of the change of state of the second receiver chain is advanced from coinciding with the Sub2 slot boundary to coinciding with the Sub1 slot boundary. In other examples, in response to the Sub2 slot boundary being ahead of the Sub1 slot boundary, the timing of the change of state of the second receiver chain is delayed from coinciding with the Sub2 slot boundary to coinciding with the Sub1 slot boundary.

At block 1810, the apparatus may temporarily increase a first bandwidth of a DC notch filter associated with a DC estimator of the first receiver chain to a second bandwidth at a same time as the Sub1 slot boundary. For example, the second bandwidth may revert to the first bandwidth, narrower than the second bandwidth, after a predetermined number of symbols associated with the first signal. In some examples, the predetermined number of symbols may be between one and three symbols, inclusive. In some examples, the predetermined number may be 2 symbols. For example, the gear shifting circuitry 1544 as shown and described in connection with FIG. 15, may provide a means for temporarily increasing a first bandwidth of a DC notch filter associated with a DC estimator of the first receiver chain to a second bandwidth at a same time as the Sub1 slot boundary The gear shifting circuitry 1544 may also provide a means for reverting the second bandwidth to the first bandwidth, narrower than the second bandwidth, after a predetermined number of symbols associated with the first signal.

According to some aspects, a DC shift of the first signal at an analog output of the first receiver chain may occur in response to the change of the state of the second receiver chain, and the temporarily increasing the first bandwidth to the second bandwidth reduces a time it takes the DC estimator to settle toward a final estimated DC value of the first signal after the DC shift in comparison to the time it would take to settle toward the final estimated DC value without temporarily increasing the first bandwidth to the second bandwidth.

According to some aspects, the process 1800 may further include, in response to the apparatus being reconfigured to operate in a single subscriber identity module mode, receiving the first signal at the first receiver chain of the two receiver chain downlink pipe, and receiving the first signal at the second receiver chain of the two receiver chain downlink pipe, the second receiver chain serving as a diversity receiver chain. For example, the communication and processing circuitry 1541 as shown and described in connection with FIG. 15, may provide a means for receiving the first signal at the first receiver chain of the two receiver chain downlink pipe, and means for receiving the first signal at the second receiver chain of the two receiver chain downlink pipe, the second receiver chain serving as a diversity receiver chain.

According to some aspects, the process 1800 may further include, storing a first output value of the DC estimator during an on state of the first receiver chain and the second receiver chain, and utilizing the first output value as an initial seed value applied to the DC estimator in conjunction with the temporarily increasing the first bandwidth to the second bandwidth. For example, the communication and processing circuitry, in combination with the output value of DC estimator storage 1573, may provide a means for storing a first output value of the DC estimator during an on state of the first receiver chain and the second receiver chain, and utilizing the first output value as an initial seed value applied to the DC estimator in conjunction with the temporarily increasing the first bandwidth to the second bandwidth.

In some examples, the process 1800 may also include having the apparatus configure a timing control hardware circuit (e.g., of the slot/symbol tracking and timing circuitry 1543 and/or the slot/symbol boundary and timing tracking circuit 1572 as described and shown in connection with FIG. 15) to cause an adjustment of the second timing of the change of the state of the second receiver chain in response to determining whether the Sub1 slot boundary is ahead of or delayed from the Sub2 slot boundary. For example, the slot/symbol tracking and timing circuitry 1543 and/or the slot/symbol boundary and timing tracking circuit 1572, as shown and described in connection with FIG. 15, may provide a means for configuring a timing control hardware circuit to cause an adjustment of the second timing of the change of the state of the second receiver chain in response to determining whether the Sub1 slot boundary is ahead of or delayed from the Sub2 slot boundary.

Thereafter, the process 1800 may end.

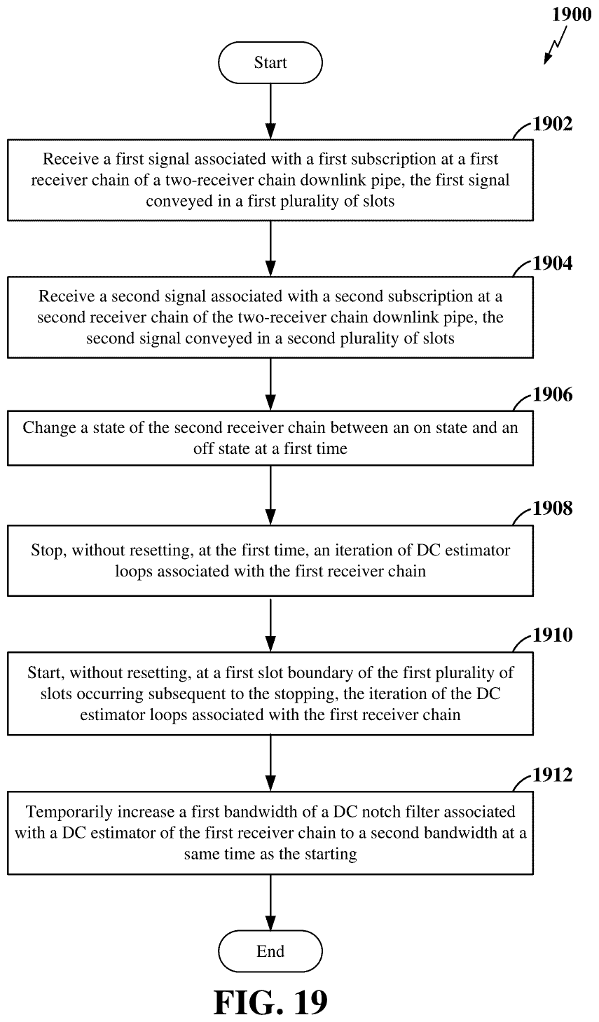

FIG. 19 is a flow chart illustrating an example process 1900 (e.g., a method) of wireless communication at an apparatus (e.g., a scheduled entity, a user equipment, a wireless communications device, a mobile communication device) according to some aspects of the disclosure. As described below, some or all illustrated features may be omitted in a particular implementation within the scope of the present disclosure, and some illustrated features may not be required for the implementation of all examples. In some examples, the process 1900 may be carried out by the apparatus 1500, as shown and described in connection with FIG. 15. The apparatus 1500 may be similar to, for example, any of the scheduled entities, user equipment, wireless communications devices, and/or mobile communication devices of FIGS. 1 and 2. In some examples, the process 1900 may be carried out by any suitable apparatus or means for carrying out the functions or algorithm described below.

At block 1902, the apparatus may receive a first signal associated with a first subscription at a first receiver chain of a two receiver chain downlink pipe, the first signal conveyed in a first plurality of slots. For example, the communication and processing circuitry 1541, in combination with the downlink pipe circuitry 1542, as shown and described in connection with FIG. 15, may provide a means for receiving a first signal associated with a first subscription at a first receiver chain of a two receiver chain downlink pipe, the first signal conveyed in a first plurality of slots. According to some aspects, the two receiver chain downlink pipe may be a sole downlink pipe of the apparatus.

At block 1904, the apparatus may receive a second signal associated with a second subscription at a second receiver chain of the two receiver chain downlink pipe, the second signal conveyed in a second plurality of slots. For example, the communication and processing circuitry 1541, in combination with the downlink pipe circuitry 1542, as shown and described in connection with FIG. 15, may provide a means for receiving a second signal associated with a second subscription at a second receiver chain of the two receiver chain downlink pipe, the second signal conveyed in a second plurality of slots.

At block 1906, the apparatus may change a state of the second receiver chain between an on state and an off state at a first time. For example, the change of state may be from an on state to an off state, or the off state to the on state. For example, the state changing circuitry 1545, as shown and described in connection with FIG. 15, may provide a means for the changing the state of the second receiver chain. According to some aspects, the change of the state occurs with a change of a load current of a local oscillator distribution network providing a local oscillator signal to the second receiver chain, and the change of the load current causes a DC shift of the first signal at an analog output of the first receiver chain.

At block 1908, the apparatus may stop, without resetting, at the first time, an iteration of direct current (DC) estimator loops associated with the first receiver chain. For example, the communication and processing circuitry 1541, as shown and described in connection with FIG. 15, may provide a means for stopping, without resetting, at the first time, an iteration of DC estimator loops associated with the first receiver chain.

At block 1910, the apparatus may start, without resetting, at a first slot boundary of the first plurality of slots occurring subsequent to the stopping, the iteration of the DC estimator loops associated with the first receiver chain. For example, the communication and processing circuitry 1541, as shown and described in connection with FIG. 15, may provide a means for starting, without resetting, at a first slot boundary of the first plurality of slots occurring subsequent to the stopping, the iteration of the DC estimator loops associated with the first receiver chain.

At block 1912, the apparatus may temporarily increase a first bandwidth of a DC notch filter associated with a DC estimator of the first receiver chain to a second bandwidth at a same time as the starting. For example, the second bandwidth may revert to the first bandwidth, narrower than the second bandwidth, after a predetermined number of symbols associated with the first signal. In some examples, the predetermined number of symbols may be between one and three symbols, inclusive. In some examples, the predetermined number may be 2 symbols. For example, the gear shifting circuitry 1544 as shown and described in connection with FIG. 15, may provide a means for temporarily increasing a first bandwidth of a DC notch filter associated with a DC estimator of the first receiver chain to a second bandwidth at a same time as the starting. The gear shifting circuitry 1544 may also provide a means for reverting the second bandwidth to the first bandwidth, narrower than the second bandwidth, after a predetermined number of symbols associated with the first signal.

Thereafter, the process 1900 may end.

In accordance with various aspects of the disclosure, an element, or any portion of an element, or any combination of elements may be implemented with a processing system 1514 that includes one or more processors, generally represented by processor 1504. The one or more processors (generally represented by processor 1504), as utilized in the apparatus 1500, may be configured to, individually or collectively, implement any one or more of the methods or processes described herein and illustrated, for example, in FIGS. 5, 6, 7, 9, 10-14, and/or 16-19.

Of course, in the above examples, the circuitry included in the processor 1504 of FIG. 15 is merely provided as an example. Other means for carrying out the described processes or functions may be included within various aspects of the present disclosure, including but not limited to the instructions stored in the computer-readable medium 1506 of FIG. 15 or any other suitable apparatus or means described in any one of the FIGS. 1, 2, 4, 8, and/or 15 utilizing, for example, the processes and/or algorithms described herein in relation to FIGS. 5, 6, 7, 9, 10-14, and/or 16-19.

The following provides an overview of aspects of the present disclosure:

Aspect 1: A method at an apparatus, comprising: receiving, in a multi-subscriber identity module mode, a first signal associated with a first subscription at a first receiver chain of a two receiver chain downlink pipe, the first signal conveyed in a first plurality of slots; receiving, in the multi-subscriber identity module mode, a second signal associated with a second subscription at a second receiver chain of the two receiver chain downlink pipe, the second signal conveyed in a second plurality of slots; tracking a difference in timing of a first slot boundary of the first plurality of slots and a second slot boundary of the second plurality of slots; and in response to a change of a state of the second receiver chain, one of: temporarily increasing a first bandwidth of a direct current (DC) notch filter associated with a DC estimator of the first receiver chain to a second bandwidth at a same time as the first slot boundary in response to the first slot boundary and the second slot boundary coinciding, temporarily increasing the first bandwidth to the second bandwidth prior to the first slot boundary in response to the second slot boundary being advanced in time relative to the first slot boundary, or temporarily increasing the first bandwidth to the second bandwidth subsequent to the first slot boundary in response to the second slot boundary being delayed in time relative to the first slot boundary.

Aspect 2: The method of aspect 1, wherein the change of the state is from: an on state to an off state, or the off state to the on state.

Aspect 3: The method of aspect 1 or aspect 2, further comprising: reverting the second bandwidth to the first bandwidth, narrower than the second bandwidth, after a predetermined number of symbols associated with the first signal.

Aspect 4: The method of aspect 3, wherein the predetermined number of symbols is between one and three symbols, inclusive.

Aspect 5: The method of aspect 3, wherein the predetermined number of symbols is two symbols.

Aspect 6: The method of any of aspects 1 through 5, wherein: a DC shift of the first signal at an analog output of the first receiver chain occurs in response to the change of the state of the second receiver chain, and the temporarily increasing the first bandwidth to the second bandwidth reduces a time it takes the DC estimator to settle toward a final estimated DC value of the first signal after the DC shift in comparison to the time it would take to settle toward the final estimated DC value without temporarily increasing the first bandwidth to the second bandwidth.

Aspect 7: The method of any of aspects 1 through 6, wherein the change of the state occurs with a change of a load current of a local oscillator distribution network providing a local oscillator signal to the second receiver chain, and the change of the load current causes a DC shift of the first signal at an analog output of the first receiver chain.

Aspect 8: The method of any of aspects 1 through 7, wherein the two receiver chain downlink pipe is a sole downlink pipe of the apparatus.

Aspect 9: The method of any of aspects 1 through 8, wherein in response to the apparatus being reconfigured to operate in single subscriber identity module mode, the method further comprises: receiving the first signal at the first receiver chain of the two receiver chain downlink pipe; and receiving the first signal at the second receiver chain of the two receiver chain downlink pipe, the second receiver chain serving as a diversity receiver chain.

Aspect 10: The method of any of aspects 1 through 9, further comprising: storing a first output value of the DC estimator during an on state of the first receiver chain and the second receiver chain; and utilizing the first output value as an initial seed value applied to the DC estimator in conjunction with the temporarily increasing the first bandwidth to the second bandwidth.

Aspect 11. A method at an apparatus, comprising: receiving a first signal associated with a first subscription at a first receiver chain of a two receiver chain downlink pipe; receiving a second signal associated with a second subscription at a second receiver chain of the two receiver chain downlink pipe; changing a state of the second receiver chain; and temporarily increasing, at a same time as the changing the state of the second receiver chain, a first bandwidth of a direct current (DC) notch filter associated with a DC estimator of the first receiver chain to a second bandwidth.

Aspect 12: The method of aspect 11, wherein the changing the state is from: an on state to an off state, or the off state to the on state.

Aspect 13: The method of aspect 11 or aspect 12, further comprising: reverting the second bandwidth to the first bandwidth, narrower than the second bandwidth, after a predetermined number of symbols associated with the first signal.

Aspect 14: The method of aspect 13, wherein the predetermined number of symbols is between one and three symbols, inclusive.

Aspect 15: The method of aspect 13, wherein the predetermined number of symbols is two symbols.

Aspect 16: The method of any of aspects 11 through 15, wherein: a DC shift of the first signal at an analog output of the first receiver chain occurs in response to the changing the state of the second receiver chain, and the temporarily increasing the first bandwidth to the second bandwidth reduces a time it takes the DC estimator to settle toward a final estimated DC value of the first signal after the DC shift in comparison to the time it would take to settle toward the final estimated DC value without temporarily increasing the first bandwidth to the second bandwidth.

Aspect 17: The method of any of aspects 11 through 16, wherein the changing the state occurs with a change of a load current of a local oscillator distribution network providing a local oscillator signal to the second receiver chain, and the change of the load current causes a DC shift of the first signal at an analog output of the first receiver chain.

Aspect 18: The method of any of aspects 11 through 17, wherein the two receiver chain downlink pipe is a sole downlink pipe of the apparatus.

Aspect 19: The method of any of aspects 11 through 18, wherein in response to the apparatus being reconfigured to operate in single subscriber identity module mode, the method further comprises: receiving the first signal at the first receiver chain of the two receiver chain downlink pipe, the first signal conveyed in a first plurality of slots; and receiving the first signal at the second receiver chain of the two receiver chain downlink pipe, the second signal conveyed in a second plurality of slots, the second receiver chain serving as a diversity receiver chain.

Aspect 20: The method of any of aspects 11 through 19, further comprising: storing a first output value of the DC estimator during an on state of the first receiver chain and the second receiver chain; and utilizing the first output value as an initial seed value applied to the DC estimator in conjunction with the temporarily increasing the first bandwidth to the second bandwidth.

Aspect 21. A method at an apparatus, comprising: receiving, in a multi-subscriber identity module mode, a first signal associated with a first subscription (Sub1) at a first receiver chain of a two receiver chain downlink pipe, the first signal conveyed in a first plurality of slots; receiving, in the multi-subscriber identity module mode, a second signal associated with a second subscription (Sub2) at a second receiver chain of the two receiver chain downlink pipe, the second signal conveyed in a second plurality of slots; tracking a first timing of a Sub1 slot boundary and a Sub2 slot boundary; adjusting a second timing of a change of a state of the second receiver chain from coinciding with the Sub2 slot boundary to coinciding with the Sub1 slot boundary; and temporarily increasing a first bandwidth of a direct current (DC) notch filter associated with a DC estimator of the first receiver chain to a second bandwidth at a same time as the Sub1 slot boundary.

Aspect 22: The method of aspect 21, wherein: in response to the Sub1 slot boundary being ahead of the Sub2 slot boundary, the second timing of the change of the state of the second receiver chain is advanced from coinciding with the Sub2 slot boundary to coinciding with the Sub1 slot boundary; and in response to the Sub2 slot boundary being ahead of the Sub1 slot boundary, the second timing of the change of the state of the second receiver chain is delayed from coinciding with the Sub2 slot boundary to coinciding with the Sub1 slot boundary.

Aspect 23: The method of aspect 21 or aspect 22, further comprising: configuring a timing control hardware circuit to cause the adjusting of the second timing of the change of the state of the second receiver chain in response to determining whether the Sub1 slot boundary is ahead of or delayed from the Sub2 slot boundary.

Aspect 24: The method of any of aspects 21 through 23, wherein the change of the state is from: an on state to an off state, or the off state to the on state.

Aspect 25: The method of any of aspects 21 through 24, further comprising: reverting the second bandwidth to the first bandwidth, narrower than the second bandwidth, after a predetermined number of symbols associated with the first signal.

Aspect 26: The method of aspect 25, wherein the predetermined number of symbols is between one and three symbols, inclusive.

Aspect 27: The method of aspect 25, wherein the predetermined number of symbols is two symbols.

Aspect 28: The method of any of aspects 21 through 27, wherein: a DC shift of the first signal at an analog output of the first receiver chain occurs in response to the change of the state of the second receiver chain, and the temporarily increasing the first bandwidth to the second bandwidth reduces a time it takes the DC estimator to settle toward a final estimated DC value of the first signal after the DC shift in comparison to the time it would take to settle toward the final estimated DC value without temporarily increasing the first bandwidth to the second bandwidth.

Aspect 29: The method of any of aspects 21 through 28, wherein the change of the state occurs with a change of a load current of a local oscillator distribution network providing a local oscillator signal to the second receiver chain, and the change of the load current causes a DC shift of the first signal at an analog output of the first receiver chain.

Aspect 30: The method of any of aspects 21 through 29, wherein the two receiver chain downlink pipe is a sole downlink pipe of the apparatus.

Aspect 31: The method of any of aspects 21 through 30, wherein in response to the apparatus being reconfigured to operate in single subscriber identity module mode, the method further comprises: receiving the first signal at the first receiver chain of the two receiver chain downlink pipe, the first signal conveyed in the first plurality of slots; and receiving the first signal at the second receiver chain of the two receiver chain downlink pipe, the second signal conveyed in the second plurality of slots, the second receiver chain serving as a diversity receiver chain.

Aspect 32: The method of any of aspects 21 through 31, further comprising: storing a first output value of the DC estimator during an on state of the first receiver chain and the second receiver chain; and utilizing the first output value as an initial seed value applied to the DC estimator in conjunction with the temporarily increasing the first bandwidth to the second bandwidth.

Aspect 33. A method at an apparatus, comprising: receiving a first signal associated with a first subscription at a first receiver chain of a two receiver chain downlink pipe, the first signal conveyed in a first plurality of slots; receiving a second signal associated with a second subscription at a second receiver chain of the two receiver chain downlink pipe, the second signal conveyed in a second plurality of slots; changing a state of the second receiver chain at a first time; stopping, without resetting, at the first time, an iteration of direct current (DC) estimator loops associated with the first receiver chain; starting, without resetting, at a first slot boundary of the first plurality of slots occurring subsequent to the stopping, the iteration of the DC estimator loops associated with the first receiver chain; and temporarily increasing a first bandwidth of a DC notch filter associated with a DC estimator of the first receiver chain to a second bandwidth at a same time as the starting.

Aspect 34: The method of aspect 33, wherein the changing the state is from: an on state to an off state, or the off state to the on state.

Aspect 35: The method of aspect 33 or aspect 34, further comprising: reverting the second bandwidth to the first bandwidth, narrower than the second bandwidth, after a predetermined number of symbols associated with the first signal.

Aspect 36: The method of aspect 35, wherein the predetermined number of symbols is between one and three symbols, inclusive.

Aspect 37: The method of aspect 35, wherein the predetermined number of symbols is two symbols.

Aspect 38: The method of any of aspects 33 through 37, wherein: a DC shift of the first signal at an analog output of the first receiver chain occurs in response to the changing the state of the second receiver chain, and the temporarily increasing the first bandwidth to the second bandwidth reduces a time it takes the DC estimator to settle toward a final estimated DC value of the first signal after the DC shift in comparison to the time it would take to settle toward the final estimated DC value without temporarily increasing the first bandwidth to the second bandwidth.

Aspect 39: The method of any of aspects 33 through 38, wherein the changing the state occurs with a change of a load current of a local oscillator distribution network providing a local oscillator signal to the second receiver chain, and the change of the load current causes a DC shift of the first signal at an analog output of the first receiver chain.

Aspect 40: The method of any of aspects 33 through 39, wherein the two receiver chain downlink pipe is a sole downlink pipe of the apparatus.

Aspect 41: The method of any of aspects 33 through 40, wherein in response to the apparatus being reconfigured to operate in single subscriber identity module mode, the method further comprises: receiving the first signal at the first receiver chain of the two receiver chain downlink pipe, the first signal conveyed in the first plurality of slots; and receiving the first signal at the second receiver chain of the two receiver chain downlink pipe, the second signal conveyed in the second plurality of slots, the second receiver chain serving as a diversity receiver chain.

Aspect 42: The method of any of aspects 33 through 41, further comprising: storing a first output value of the DC estimator during an on state of the first receiver chain and the second receiver chain; and utilizing the first output value as an initial seed value applied to the DC estimator in conjunction with the temporarily increasing the first bandwidth to the second bandwidth.

Aspect 43: An apparatus configured for wireless communication comprising one or more processors, and one or more memories coupled to the one or more processors, the one or more processors configured to, individually or collectively, based at least in part on information stored in the oner or more memories, perform any of the methods of any one of aspects 1 through 42.

Aspect 44: An apparatus configured for wireless communication comprising at least one means for performing any of the methods of any one of aspects 1 through 42.

Aspect 45: A non-transitory computer-readable medium storing computer-executable code, comprising code for causing an apparatus to perform any of the methods of any one of aspects 1 through 42.

Aspect 46: An apparatus, comprising: one or more memories; and one or more processors being configured to, individually or collectively, based at least in part on information stored in the one or more memories: receive, in a multi-subscriber identity module mode, a first signal associated with a first subscription at a first receiver chain of a two receiver chain downlink pipe, the first signal conveyed in a first plurality of slots; receive, in the multi-subscriber identity module mode, a second signal associated with a second subscription at a second receiver chain of the two receiver chain downlink pipe, the second signal conveyed in a second plurality of slots; track a difference in timing of a first slot boundary of the first plurality of slots and a second slot boundary of the second plurality of slots; and in response to a change of a state of the second receiver chain, one of: temporarily increase a first bandwidth of a direct current (DC) notch filter associated with a DC estimator of the first receiver chain to a second bandwidth at a same time as the first slot boundary in response to the first slot boundary and the second slot boundary coinciding, temporarily increase the first bandwidth to the second bandwidth prior to the first slot boundary in response to the second slot boundary being advanced in time relative to the first slot boundary, or temporarily increase the first bandwidth to the second bandwidth subsequent to the first slot boundary in response to the second slot boundary being delayed in time relative to the first slot boundary.

Aspect 47: An apparatus comprising: means for receiving, in a multi-subscriber identity module mode, a first signal associated with a first subscription at a first receiver chain of a two receiver chain downlink pipe, the first signal conveyed in a first plurality of slots; means for receiving, in the multi-subscriber identity module mode, a second signal associated with a second subscription at a second receiver chain of the two receiver chain downlink pipe, the second signal conveyed in a second plurality of slots; means for tracking a difference in timing of a first slot boundary of the first plurality of slots and a second slot boundary of the second plurality of slots; and in response to a change of a state of the second receiver chain, one of: means for temporarily increasing a first bandwidth of a direct current (DC) notch filter associated with a DC estimator of the first receiver chain to a second bandwidth at a same time as the first slot boundary in response to the first slot boundary and the second slot boundary coinciding, means for temporarily increasing the first bandwidth to the second bandwidth prior to the first slot boundary in response to the second slot boundary being advanced in time relative to the first slot boundary, or means for temporarily increasing the first bandwidth to the second bandwidth subsequent to the first slot boundary in response to the second slot boundary being delayed in time relative to the first slot boundary.

Aspect 48: A non-transitory computer-readable medium storing computer-executable code, comprising code for causing an apparatus to: receive, in a multi-subscriber identity module mode, a first signal associated with a first subscription at a first receiver chain of a two receiver chain downlink pipe, the first signal conveyed in a first plurality of slots; receive, in the multi-subscriber identity module mode, a second signal associated with a second subscription at a second receiver chain of the two receiver chain downlink pipe, the second signal conveyed in a second plurality of slots; track a difference in timing of a first slot boundary of the first plurality of slots and a second slot boundary of the second plurality of slots; and in response to a change of a state of the second receiver chain, one of: temporarily increase a first bandwidth of a direct current (DC) notch filter associated with a DC estimator of the first receiver chain to a second bandwidth at a same time as the first slot boundary in response to the first slot boundary and the second slot boundary coinciding, temporarily increase the first bandwidth to the second bandwidth prior to the first slot boundary in response to the second slot boundary being advanced in time relative to the first slot boundary, or temporarily increase the first bandwidth to the second bandwidth subsequent to the first slot boundary in response to the second slot boundary being delayed in time relative to the first slot boundary.

Aspect 49: An apparatus, comprising: one or more memories; and one or more processors being configured to, individually or collectively, based at least in part on information stored in the one or more memories: receive a first signal associated with a first subscription at a first receiver chain of a two receiver chain downlink pipe; receive a second signal associated with a second subscription at a second receiver chain of the two receiver chain downlink pipe; change a state of the second receiver chain; and temporarily increase, at a same time as the changing the state of the second receiver chain, a first bandwidth of a direct current (DC) notch filter associated with a DC estimator of the first receiver chain to a second bandwidth.

Aspect 50: An apparatus comprising: means for receiving a first signal associated with a first subscription at a first receiver chain of a two receiver chain downlink pipe; means for receiving a second signal associated with a second subscription at a second receiver chain of the two receiver chain downlink pipe; means for changing a state of the second receiver chain; and means for temporarily increasing, at a same time as the changing the state of the second receiver chain, a first bandwidth of a direct current (DC) notch filter associated with a DC estimator of the first receiver chain to a second bandwidth.

Aspect 51: A non-transitory computer-readable medium storing computer-executable code, comprising code for causing an apparatus to: receive a first signal associated with a first subscription at a first receiver chain of a two receiver chain downlink pipe; receive a second signal associated with a second subscription at a second receiver chain of the two receiver chain downlink pipe; change a state of the second receiver chain; and temporarily increase, at a same time as the changing the state of the second receiver chain, a first bandwidth of a direct current (DC) notch filter associated with a DC estimator of the first receiver chain to a second bandwidth.

Aspect 52: An apparatus, comprising: one or more memories; and one or more processors being configured to, individually or collectively, based at least in part on information stored in the one or more memories: receive, in a multi-subscriber identity module mode, a first signal associated with a first subscription (Sub1) at a first receiver chain of a two receiver chain downlink pipe, the first signal conveyed in a first plurality of slots; receive, in the multi-subscriber identity module mode, a second signal associated with a second subscription (Sub2) at a second receiver chain of the two receiver chain downlink pipe, the second signal conveyed in a second plurality of slots; track a first timing of a Sub1 slot boundary and a Sub2 slot boundary; adjust a second timing of a change of a state of the second receiver chain from coinciding with the Sub2 slot boundary to coinciding with the Sub1 slot boundary; and temporarily increase a first bandwidth of a direct current (DC) notch filter associated with a DC estimator of the first receiver chain to a second bandwidth at a same time as the Sub1 slot boundary.

Aspect 53: An apparatus comprising: means for receiving, in a multi-subscriber identity module mode, a first signal associated with a first subscription (Sub1) at a first receiver chain of a two receiver chain downlink pipe, the first signal conveyed in a first plurality of slots; means for receiving, in the multi-subscriber identity module mode, a second signal associated with a second subscription (Sub2) at a second receiver chain of the two receiver chain downlink pipe, the second signal conveyed in a second plurality of slots; means for tracking a first timing of a Sub1 slot boundary and a Sub2 slot boundary; means for adjusting a second timing of a change of a state of the second receiver chain from coinciding with the Sub2 slot boundary to coinciding with the Sub1 slot boundary; and means for temporarily increasing a first bandwidth of a direct current (DC) notch filter associated with a DC estimator of the first receiver chain to a second bandwidth at a same time as the Sub1 slot boundary.

Aspect 54: A non-transitory computer-readable medium storing computer-executable code, comprising code for causing an apparatus to: receive, in a multi-subscriber identity module mode, a first signal associated with a first subscription (Sub1) at a first receiver chain of a two receiver chain downlink pipe, the first signal conveyed in a first plurality of slots; receive, in the multi-subscriber identity module mode, a second signal associated with a second subscription (Sub2) at a second receiver chain of the two receiver chain downlink pipe, the second signal conveyed in a second plurality of slots; track a first timing of a Sub1 slot boundary and a Sub2 slot boundary; adjust a second timing of a change of a state of the second receiver chain from coinciding with the Sub2 slot boundary to coinciding with the Sub1 slot boundary; and temporarily increase a first bandwidth of a direct current (DC) notch filter associated with a DC estimator of the first receiver chain to a second bandwidth at a same time as the Sub1 slot boundary.

Aspect 55: An apparatus, comprising: one or more memories; and one or more processors being configured to, individually or collectively, based at least in part on information stored in the one or more memories: receive a first signal associated with a first subscription at a first receiver chain of a two receiver chain downlink pipe, the first signal conveyed in a first plurality of slots; receive a second signal associated with a second subscription at a second receiver chain of the two receiver chain downlink pipe, the second signal conveyed in a second plurality of slots; change a state of the second receiver chain at a first time; stop, without resetting, at the first time, an iteration of direct current (DC) estimator loops associated with the first receiver chain; start, without resetting, at a first slot boundary of the first plurality of slots occurring subsequent to the stopping, the iteration of the DC estimator loops associated with the first receiver chain; and temporarily increase a first bandwidth of a DC notch filter associated with a DC estimator of the first receiver chain to a second bandwidth at a same time as the starting.

Aspect 56: An apparatus comprising: means for receiving a first signal associated with a first subscription at a first receiver chain of a two receiver chain downlink pipe, the first signal conveyed in a first plurality of slots; means for receiving a second signal associated with a second subscription at a second receiver chain of the two receiver chain downlink pipe, the second signal conveyed in a second plurality of slots; means for changing a state of the second receiver chain at a first time; means for stopping, without resetting, at the first time, an iteration of direct current (DC) estimator loops associated with the first receiver chain; means for starting, without resetting, at a first slot boundary of the first plurality of slots occurring subsequent to the stopping, the iteration of the DC estimator loops associated with the first receiver chain; and means for temporarily increasing a first bandwidth of a DC notch filter associated with a DC estimator of the first receiver chain to a second bandwidth at a same time as the starting.

Aspect 57: A non-transitory computer-readable medium storing computer-executable code, comprising code for causing an apparatus to: receive a first signal associated with a first subscription at a first receiver chain of a two receiver chain downlink pipe, the first signal conveyed in a first plurality of slots; receive a second signal associated with a second subscription at a second receiver chain of the two receiver chain downlink pipe, the second signal conveyed in a second plurality of slots; change a state of the second receiver chain at a first time; stop, without resetting, at the first time, an iteration of direct current (DC) estimator loops associated with the first receiver chain; start, without resetting, at a first slot boundary of the first plurality of slots occurring subsequent to the stopping, the iteration of the DC estimator loops associated with the first receiver chain; and temporarily increase a first bandwidth of a DC notch filter associated with a DC estimator of the first receiver chain to a second bandwidth at a same time as the starting.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features, and/or functions illustrated in FIGS. 1-19 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-19 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein. While some examples illustrated herein depict only time and frequency domains, additional domains such as a spatial domain are also contemplated in this disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

The word “obtain” as used herein may mean, for example, acquire, calculate, construct, derive, determine, receive, and/or retrieve. The preceding list is exemplary and not limiting. All structural and functional equivalents to the elements of the various aspects described throughout this disclosure that are known or later come to be known to persons of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

As used herein, the term “determine” or “determining” encompasses a wide variety of actions and, therefore, “determining” can include calculating, computing, processing, deriving, investigating, looking up (such as via looking up in a table, a database, or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing, and other similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Similarly, a phrase referring to A and/or B may include A only, B only, or a combination of A and B.

As used herein, “based on” is intended to be interpreted in the inclusive sense, unless otherwise explicitly indicated. For example, “based on” may be used interchangeably with “based at least in part on,” “associated with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A method at an apparatus, comprising:
receiving, in a multi-subscriber identity module mode, a first signal associated with a first subscription at a first receiver chain of a two receiver chain downlink pipe, the first signal conveyed in a first plurality of slots;
receiving, in the multi-subscriber identity module mode, a second signal associated with a second subscription at a second receiver chain of the two receiver chain downlink pipe, the second signal conveyed in a second plurality of slots;
tracking a difference in timing of a first slot boundary of the first plurality of slots and a second slot boundary of the second plurality of slots; and
in response to a change of a state of the second receiver chain, one of:
temporarily increasing a first bandwidth of a direct current (DC) notch filter associated with a DC estimator of the first receiver chain to a second bandwidth at a same time as the first slot boundary in response to the first slot boundary and the second slot boundary coinciding,
temporarily increasing the first bandwidth to the second bandwidth prior to the first slot boundary in response to the second slot boundary being advanced in time relative to the first slot boundary, or
temporarily increasing the first bandwidth to the second bandwidth subsequent to the first slot boundary in response to the second slot boundary being delayed in time relative to the first slot boundary.

2. The method of claim 1, further comprising:
reverting the second bandwidth to the first bandwidth, narrower than the second bandwidth, after a predetermined number of symbols associated with the first signal.

3. The method of claim 1, wherein:
a DC shift of the first signal at an analog output of the first receiver chain occurs in response to the change of the state of the second receiver chain, and
the temporarily increasing the first bandwidth to the second bandwidth reduces a time it takes the DC estimator to settle toward a final estimated DC value of the first signal after the DC shift in comparison to the time it would take to settle toward the final estimated DC value without temporarily increasing the first bandwidth to the second bandwidth.

4. The method of claim 1, wherein the two receiver chain downlink pipe is a sole downlink pipe of the apparatus.

5. The method of claim 1, wherein in response to the apparatus being reconfigured to operate in single subscriber identity module mode, the method further comprises:
receiving the first signal at the first receiver chain of the two receiver chain downlink pipe; and
receiving the first signal at the second receiver chain of the two receiver chain downlink pipe, the second receiver chain serving as a diversity receiver chain.

6. The method of claim 1, further comprising:
storing a first output value of the DC estimator during an on state of the first receiver chain and the second receiver chain; and
utilizing the first output value as an initial seed value applied to the DC estimator in conjunction with the temporarily increasing the first bandwidth to the second bandwidth.

7. A method at an apparatus, comprising:
receiving, in a multi-subscriber identity module mode, a first signal associated with a first subscription (Sub1) at a first receiver chain of a two receiver chain downlink pipe, the first signal conveyed in a first plurality of slots;
receiving, in the multi-subscriber identity module mode, a second signal associated with a second subscription (Sub2) at a second receiver chain of the two receiver chain downlink pipe, the second signal conveyed in a second plurality of slots;
tracking a first timing of a Sub1 slot boundary and a Sub2 slot boundary;
adjusting a second timing of a change of a state of the second receiver chain from coinciding with the Sub2 slot boundary to coinciding with the Sub1 slot boundary; and
temporarily increasing a first bandwidth of a direct current (DC) notch filter associated with a DC estimator of the first receiver chain to a second bandwidth at a same time as the Sub1 slot boundary.

8. The method of claim 7, wherein:
in response to the Sub1 slot boundary being ahead of the Sub2 slot boundary, the second timing of the change of the state of the second receiver chain is advanced from coinciding with the Sub2 slot boundary to coinciding with the Sub1 slot boundary; and
in response to the Sub2 slot boundary being ahead of the Sub1 slot boundary, the second timing of the change of the state of the second receiver chain is delayed from coinciding with the Sub2 slot boundary to coinciding with the Sub1 slot boundary.

9. The method of claim 7, further comprising:
configuring a timing control hardware circuit to cause the adjusting the second timing of the change of the state of the second receiver chain in response to determining whether the Sub1 slot boundary is ahead of or delayed from the Sub2 slot boundary.

10. The method of claim 7, further comprising:
reverting the second bandwidth to the first bandwidth, narrower than the second bandwidth, after a predetermined number of symbols associated with the first signal.

11. The method of claim 7, wherein:
a DC shift of the first signal at an analog output of the first receiver chain occurs in response to the change of the state of the second receiver chain, and
the temporarily increasing the first bandwidth to the second bandwidth reduces a time it takes the DC estimator to settle toward a final estimated DC value of the first signal after the DC shift in comparison to the time it would take to settle toward the final estimated DC value without temporarily increasing the first bandwidth to the second bandwidth.

12. The method of claim 7, wherein the two receiver chain downlink pipe is a sole downlink pipe of the apparatus.

13. The method of claim 7, wherein in response to the apparatus being reconfigured to operate in single subscriber identity module mode, the method further comprises:
receiving the first signal at the first receiver chain of the two receiver chain downlink pipe, the first signal conveyed in the first plurality of slots; and
receiving the first signal at the second receiver chain of the two receiver chain downlink pipe, the second signal conveyed in the second plurality of slots, the second receiver chain serving as a diversity receiver chain.

14. The method of claim 7, further comprising:
storing a first output value of the DC estimator during an on state of the first receiver chain and the second receiver chain; and
utilizing the first output value as an initial seed value applied to the DC estimator in conjunction with the temporarily increasing the first bandwidth to the second bandwidth.

15. A method at an apparatus, comprising:
receiving a first signal associated with a first subscription at a first receiver chain of a two receiver chain downlink pipe, the first signal conveyed in a first plurality of slots;
receiving a second signal associated with a second subscription at a second receiver chain of the two receiver chain downlink pipe, the second signal conveyed in a second plurality of slots;
changing a state of the second receiver chain at a first time;
stopping, without resetting, at the first time, an iteration of direct current (DC) estimator loops associated with the first receiver chain;
starting, without resetting, at a first slot boundary of the first plurality of slots occurring subsequent to the stopping, the iteration of the DC estimator loops associated with the first receiver chain; and
temporarily increasing a first bandwidth of a DC notch filter associated with a DC estimator of the first receiver chain to a second bandwidth at a same time as the starting.

16. The method of claim 15, further comprising:
reverting the second bandwidth to the first bandwidth, narrower than the second bandwidth, after a predetermined number of symbols associated with the first signal.

17. The method of claim 15, wherein:
a DC shift of the first signal at an analog output of the first receiver chain occurs in response to the changing the state of the second receiver chain, and
the temporarily increasing the first bandwidth to the second bandwidth reduces a time it takes the DC estimator to settle toward a final estimated DC value of the first signal after the DC shift in comparison to the time it would take to settle toward the final estimated DC value without temporarily increasing the first bandwidth to the second bandwidth.

18. The method of claim 15, wherein the two receiver chain downlink pipe is a sole downlink pipe of the apparatus.

19. The method of claim 15, wherein in response to the apparatus being reconfigured to operate in single subscriber identity module mode, the method further comprises:
receiving the first signal at the first receiver chain of the two receiver chain downlink pipe, the first signal conveyed in the first plurality of slots; and
receiving the first signal at the second receiver chain of the two receiver chain downlink pipe, the second signal conveyed in the second plurality of slots, the second receiver chain serving as a diversity receiver chain.

20. The method of claim 15, further comprising:
storing a first output value of the DC estimator during an on state of the first receiver chain and the second receiver chain; and
utilizing the first output value as an initial seed value applied to the DC estimator in conjunction with the temporarily increasing the first bandwidth to the second bandwidth.
